(19) United States
(12) Patent Application Publication
(10) Pub. No.: US 2025/0389824 A1
(43) Pub. Date: Dec. 25, 2025

(54) TIME OF FLIGHT STATISTICS DEVICE AND LASER RANGING DEVICE

(71) Applicant: SUTENG INNOVATION TECHNOLOGY CO., LTD., Shenzhen (CN)

(72) Inventors: Wei TAN, Shenzhen (CN); Junling ZANG, Shenzhen (CN)

(73) Assignee: SUTENG INNOVATION TECHNOLOGY CO., LTD., Shenzhen (CN)

(21) Appl. No.: 19/312,279

(22) Filed: Aug. 27, 2025

Related U.S. Application Data
(63) Continuation of application No. PCT/CN2023/078837, filed on Feb. 28, 2023.

(51) Int. Cl. G01S 7/4865; G01S 17/10

(52) U.S. Cl. CPC G01S 7/4865; G01S 17/10

(57) ABSTRACT

The application provides a time of flight (TOF) statistical device and a laser ranging device. The TOF statistical device includes a statistical unit and a memory. The statistical unit is used for obtaining S first initial time of flight data sets in S first integration periods, performing accumulation processing on each first initial time of flight data set in each group of every adjacent N first initial time of flight data to obtain S accumulated time of flight data sets corresponding to the S first initial time of flight data sets, and performing superposition processing on the S accumulated time of flight data sets to obtain a superposition time of flight data set, where S is a positive integer greater than or equal to 2, and Nis a positive integer greater than or equal to 2.

### CROSS-REFERENCE TO RELATED APPLICATION

The present application claims the benefit of priority to International Patent Application No. PCT/CN2023/078837, filed on Feb. 28, 2023, which is hereby incorporated by reference in its entirety.

### TECHNICAL FIELD

The application relates to the technical field of laser ranging, in particular to a time of flight (TOF) statistical device and a laser ranging device.

### BACKGROUND

At present, a laser ranging device uses a time of flight (TOF) technology to measure the distance of a target object, and has important applications in various three-dimensional ranging and three-dimensional imaging fields, such as automatic driving, face recognition, 3D games, virtual reality, and the like. Specifically, the laser ranging device uses a light source to emit a continuous or pulsed outgoing light beam, and uses a photoelectric sensor to receive a returned echo light beam after the outgoing light beam is reflected by the target object. The distance of the measured target, that is, depth information, is obtained by counting the time of flight between the emitted outgoing light beam and the echo light beam.

In the process of counting the time of flight, the capacity of the memory used for storing the time of flight is limited, so that the countable time of flight data is limited, and thus the detection distance of the laser ranging device is limited. How to increase the detection distance of the laser ranging device has become a technical problem to be solved by those skilled in the art.

### SUMMARY

The application provides a time of flight statistical device and a laser ranging device, and the detection distance of the laser ranging device can be increased.

In a first aspect, the application provides a time of flight statistical device, which includes a statistical unit and a memory.

The statistical unit is used for obtaining S first initial time of flight data sets in S first integration periods, and performing accumulation processing on each first initial time of flight data set in groups of every N adjacent first initial time of flight data to obtain S accumulated time of flight data sets corresponding to the S first initial time of flight data sets in one-to-one manner, where S is a positive integer greater than or equal to 2, and N is a positive integer greater than or equal to 2. Each first initial time of flight data set includes a plurality of first initial time of flight data corresponding to a plurality of flight moments in one-to-one manner, and each accumulated time of flight data set includes at least one accumulated photon count value corresponding to at least one accumulated flight moment in one-to-one manner.

The statistical unit is further used for performing superposition processing on the S accumulated time of flight data sets to obtain a superposition time of flight data set, and storing the superposition time of flight data set in the memory in a manner that at least one superposition photon count value in the superposition time of flight data set is stored in one memory unit according to one superposition photon count value, and the superposition time of flight data set includes a superposition photon count value corresponding to each accumulated flight moment in one-to-one manner.

In a second aspect, the application further provides a time of flight statistical device, which includes a statistical unit and a memory.

When the time-of-flight statistical device is in the first detection mode, the statistical unit is configured to acquire S first initial time-of-flight data sets in S first integration periods, and perform accumulation processing on each first initial time-of-flight data set in groups of every N adjacent first initial time-of-flight data to obtain S accumulated time-of-flight data sets corresponding to the S first initial time-of-flight data sets in a one-to-one manner, S being a positive integer greater than or equal to 2, and N being a positive integer greater than or equal to 2. Each first initial time-of-flight data set includes a plurality of first initial time-of-flight data corresponding to a plurality of flight moments in a one-to-one manner, and each accumulated time-of-flight data set includes at least one accumulated photon count value corresponding to at least one accumulated flight moment in a one-to-one manner. The statistical unit is further configured to perform superposition processing on the S accumulated time-of-flight data sets to obtain a first superposition time-of-flight data set, and store the first superposition time-of-flight data set in the memory in a manner that at least one first superposition photon count value in the first superposition time-of-flight data set is stored in one storage unit in one first superposition photon count value, the first superposition time-of-flight data set including a first superposition photon count value corresponding to each accumulated flight moment in a one-to-one manner.

When the time-of-flight statistical device is in the second detection mode, the statistical unit is configured to acquire S second initial time-of-flight data sets in S second integration periods, perform superposition processing on the S second initial time-of-flight data sets to obtain a second superposition time-of-flight data set, and store the second superposition time-of-flight data set in the memory in a manner that at least one second superposition photon count value in the second superposition time-of-flight data set is stored in one storage unit in one second superposition photon count value, the second superposition time-of-flight data set including a second superposition photon count value corresponding to each flight moment. Each second initial time-of-flight data set includes a plurality of second initial time-of-flight data corresponding to a plurality of flight moments in a one-to-one manner.

In a third aspect, the embodiment of the application provides a laser ranging device, including the time-of-flight statistical device in any one of the first aspect and the second aspect.

In a fourth aspect, the embodiment of the application provides a time-of-flight statistical method, including:

acquiring S first initial time-of-flight data sets in S first integration periods, and performing accumulation processing on each first initial time-of-flight data set in groups of every N adjacent first initial time-of-flight data to obtain S accumulated time-of-flight data sets corresponding to the S first initial time-of-flight data sets in a one-to-one manner, S being a positive integer greater than or equal to 2, and N being a positive integer greater than or equal to 2. Each first initial time-of-flight data set includes a plurality of first initial time-of-flight data corresponding to a plurality of flight moments in a one-to-one manner, and each accumulated time-of-flight data set includes at least one accumulated photon count value corresponding to at least one accumulated flight moment in a one-to-one manner.

The S sets of accumulated flight time data are superimposed to obtain a set of superimposed flight time data, and the set of superimposed flight time data is stored in the memory in a manner that at least one superimposed photon count value in the set of superimposed flight time data is stored in one storage unit according to one superimposed photon count value. The set of superimposed flight time data includes the superimposed photon count value corresponding to each accumulated flight time.

In a fifth aspect, the embodiment of the application further provides a time of flight statistical method, which includes:

In the first detection mode, S sets of first initial flight time data in S first integration periods are acquired, and each set of first initial flight time data is accumulated in groups of every N adjacent first initial flight time data to obtain S sets of accumulated flight time data corresponding to the S sets of first initial flight time data, where S is a positive integer greater than or equal to 2, and N is a positive integer greater than or equal to 2. Each set of first initial flight time data includes a plurality of first initial flight time data corresponding to a plurality of flight times, and each set of accumulated flight time data includes at least one accumulated photon count value corresponding to at least one accumulated flight time. The S sets of accumulated flight time data are superimposed to obtain a set of superimposed flight time data, and the set of superimposed flight time data is stored in the memory in a manner that at least one superimposed photon count value in the set of superimposed flight time data is stored in one storage unit according to one superimposed photon count value, the set of superimposed flight time data including the superimposed photon count value corresponding to each accumulated flight time.

In the second detection mode, S sets of second initial flight time data in S second integration periods are acquired, the S sets of second initial flight time data are superimposed to obtain a second set of superimposed flight time data, and the second set of superimposed flight time data is stored in the memory in a manner that at least one second superimposed photon count value in the second set of superimposed flight time data is stored in one storage unit according to one second superimposed photon count value, the second set of superimposed flight time data including the second superimposed photon count value corresponding to each flight time, and each set of second initial flight time data including second initial flight time data corresponding to a plurality of flight times.

In a sixth aspect, the embodiment of the application provides a computer readable storage medium. The computer readable storage medium stores a computer program, and the computer program is executed by a processor to implement the method in any one of the fourth aspect and the fifth aspect.

In a seventh aspect, the embodiment of the application provides a computer program product. When the computer program product is run on a time of flight statistical device, the time of flight statistical device executes the method in any one of the fourth aspect and the fifth aspect.

Compared with the prior art, embodiments of the current application have the beneficial effects as follows.

The time-of-flight statistical device can obtain S first initial time-of-flight data sets corresponding to S first integration periods, sample the first initial time-of-flight data in each first initial time-of-flight data set according to every N adjacent time-of-flight data, obtain an accumulated photon count value of the N adjacent first initial time-of-flight data, and store the accumulated photon count value in a storage unit. If the memory includes X*M storage units, the statistical device can enable the memory to store X*M (X*K*N) accumulated photon count values. Each first integration period can include X*N clock periods. Compared with the prior detection method in which M initial time-of-flight data of each clock period are respectively stored in M storage units and one integration period includes only X clock periods, the time-of-flight statistical device provided by the present application allows the memory to store more initial time-of-flight data corresponding to clock periods, thereby increasing the detection distance of the laser ranging device and meeting the requirement for long-range detection.

### BRIEF DESCRIPTION OF DRAWINGS

In order to clearly illustrate the technical solutions in the embodiments of the present application, the following briefly describes the drawings used in the embodiments or in the description of the related art. It is apparent that the following drawings are only some embodiments of the present application, and for those of ordinary skill in the art, other drawings can be obtained according to these drawings without creative efforts.

FIG. 1 is a schematic diagram of a structure of a laser ranging device according to an embodiment of the present application;

FIG. 2 is a schematic diagram of a structure of a time-of-flight statistical device according to an embodiment of the present application;

FIG. 3 is a schematic diagram of a principle of data statistics of a time-of-flight statistical device according to an embodiment of the present application;

FIG. 4 is a schematic diagram of a statistical module according to an embodiment of the present application;

FIG. 5 is a schematic diagram of a control signal according to an embodiment of the present application;

FIG. 6 is a schematic diagram of a specific structure of a statistical module according to an embodiment of the present application;

FIG. 7 is a schematic diagram of storage of time-of-flight data in a first integration period according to an embodiment of the present application;

FIG. 8 is a schematic diagram of a specific structure of a time-of-flight statistical device according to an embodiment of the present application;

FIG. 9 is a timing diagram of a first integration period according to an embodiment of the present application;

FIG. 10 is a schematic diagram of another time-of-flight statistical device according to an embodiment of the present application;

FIG. 11 is a schematic diagram of another statistical module according to an embodiment of the present application;

FIG. 12 is a schematic diagram of a specific structure of another statistical module according to an embodiment of the present application;

FIG. 13 is a schematic diagram of storage of time-of-flight data in a first integration period according to an embodiment of the present application;

FIG. 14 is a schematic diagram of a specific structure of another time-of-flight statistical device according to an embodiment of the present application; and

FIG. 15a and FIG. 15b are another timing diagrams of a first integration period according to an embodiment of the present application.

### DETAILED DESCRIPTION

In order to make the objectives, technical schemes, and advantages of the embodiments of the present application clearer, the technical schemes in the embodiments of the present application will be described below in conjunction with the drawings in the embodiments of the present application. Obviously, the described embodiments are some but not all of the embodiments of the present application. Based on the embodiments in the present application, all other embodiments obtained by those skilled in the art without creative work are within the protection scope of the present application.

### Embodiment 1

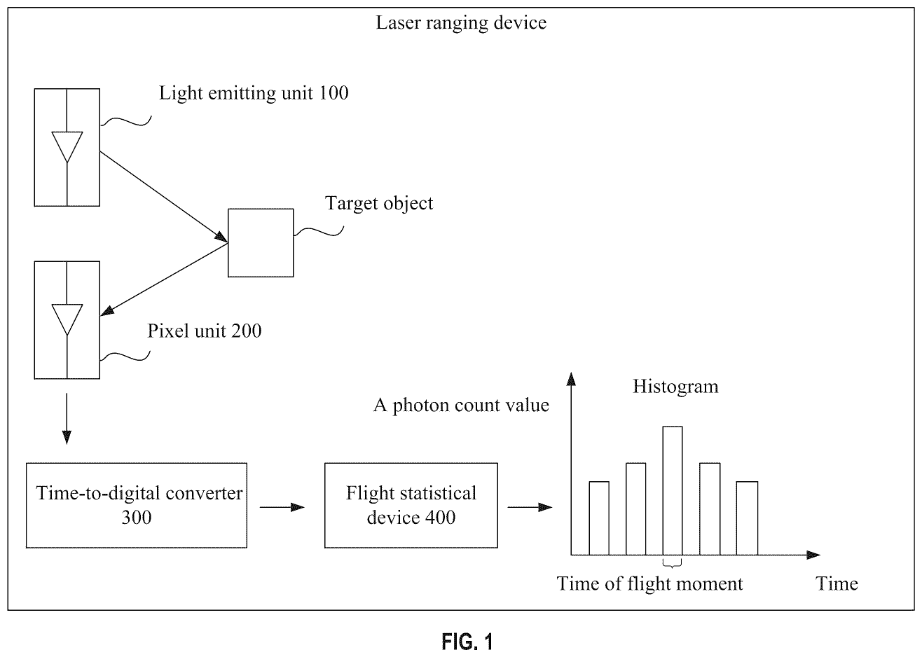

Referring to FIG. 1, a schematic diagram of a structure of a laser ranging device is provided. In the embodiment of the present application, the laser ranging device includes a light emitting unit 100, a pixel unit 200, a time-to-digital converter 300 (TDC), and a time of flight statistical device 400.

Specifically, the light emitting unit 100 is configured to emit a laser pulse signal to a target object in a detection region. The pixel unit 200 is configured to receive an echo laser signal after the laser pulse signal is reflected by the target object in the detection region, and output an echo electric signal. The pixel unit 200 can include one or more single photon avalanche diodes (SPADs). The time-to-digital converter 300 is configured to generate at least one initial time of flight data according to the echo electric signal, each initial time of flight data being used for representing a photon event corresponding to a time of flight moment, and the initial time of flight data including the time of flight moment and a photon count value corresponding to the time of flight moment.

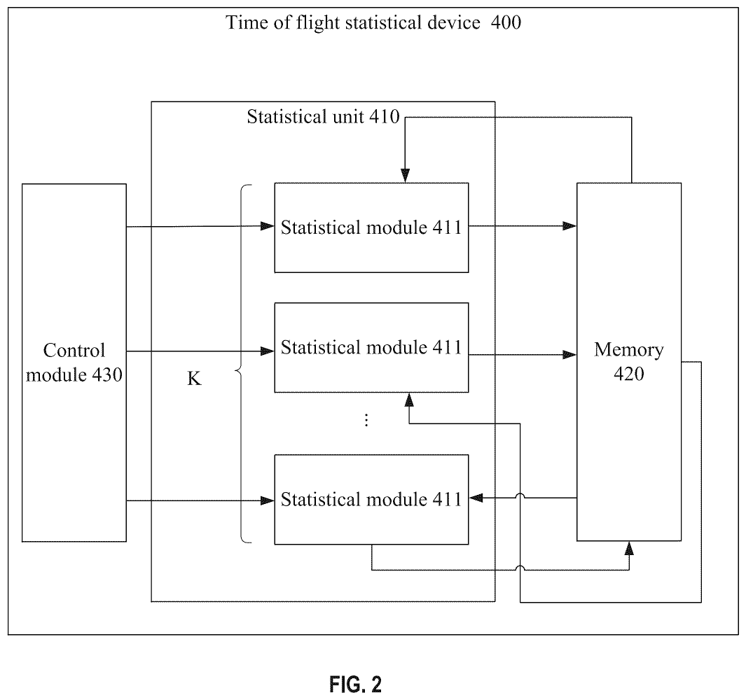

In an implementation, referring to a schematic diagram of a structure of a time of flight statistical device shown in FIG. 2, the time of flight statistical device 400 includes a statistical unit 410, a memory 420, and a control module 430. The memory 420 includes a plurality of storage units. The statistical unit 410 is configured to acquire S first initial time of flight data sets, and perform accumulation processing on each first initial time of flight data set in a group of every N adjacent initial time of flight data, to generate S accumulated time of flight data sets corresponding to the S first initial time of flight data sets in a one-to-one manner. The statistical unit 410 is further configured to perform superposition processing on the S accumulated time of flight data sets, to generate a superposition time of flight data set, and store the superposition time of flight data set in the memory 420 in a manner that one superposition time of flight data is stored in one storage unit, the superposition time of flight data set including a plurality of superposition time of flight data, where S is a positive integer and S is greater than or equal to 2. The laser ranging device can obtain histogram data according to the superposition time of flight data set stored in the memory 420, determine a time of flight from the histogram data, and obtain a distance of the target object according to the time of flight, thereby achieving a detection function.

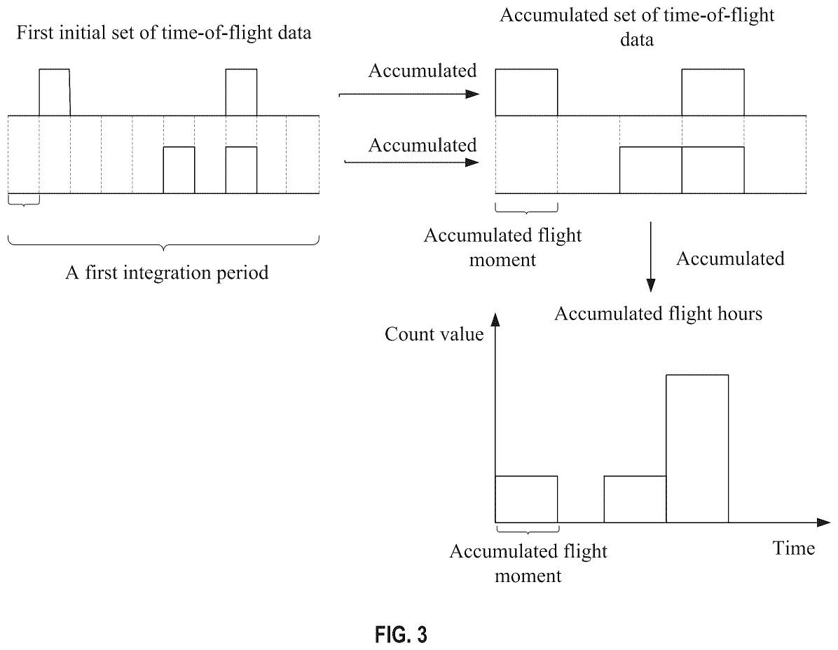

For example, referring to a schematic diagram of the time-of-flight statistical device shown in FIG. 3, each first initial time-of-flight data set includes a plurality of first initial time-of-flight data, for representing photon events in a first integration period. Each accumulated time-of-flight data set includes at least one accumulated time-of-flight data, and each accumulated time-of-flight data includes at least one accumulated flight time obtained by accumulating N first initial time-of-flight data corresponding to N adjacent flight times, and at least one accumulated photon count value corresponding to the at least one accumulated flight time. The superimposed time-of-flight data set includes superimposed time-of-flight data obtained by superimposing accumulated time-of-flight data in S accumulated time-of-flight data sets, and each superimposed time-of-flight data includes a superimposed photon count value corresponding to each accumulated flight time. For example, assuming that S=2 and N=2, two first initial time-of-flight data sets corresponding to two first integration periods are shown in FIG. 3, and two accumulated time-of-flight data sets are generated by accumulating each group of two adjacent initial time-of-flight data. Each accumulated time-of-flight data includes an accumulated flight time obtained by accumulating two initial time-of-flight data corresponding to two adjacent flight times, and an accumulated photon count value corresponding to each accumulated flight time. The superimposed time-of-flight data set is obtained by superimposing accumulated photon count values corresponding to the same accumulated flight time in the two accumulated time-of-flight data sets.

As an example but not limitation, the laser ranging device in the embodiment of the present application can be a solid-state laser radar, and can be used for navigation obstacle avoidance, obstacle recognition, ranging, speed measurement, automatic driving, and other functions of products such as automobiles, robots, logistics vehicles, inspection vehicles, and the like.

It can be understood that, since the movement speed of the target object is much smaller than the speed of light, the distance of the target object in a single time frame can be regarded as remaining unchanged. The light emitting unit 100 in the laser ranging device can emit S pulse signals in a single time frame, and accordingly, the pixel unit 200 can correspondingly receive S echo laser signals after S pulse signals are reflected by the target object in S first integration periods. At this time, the laser ranging device obtains a histogram based on the superimposed time-of-flight data set stored in the memory 420, and confirms the time of flight according to a flight time corresponding to a photon count value maximum in the histogram.

In the embodiment, in a single time frame, each of the S first integration periods includes the same number of clock periods, and each first integration period includes a plurality of clock periods, and each clock period includes M flight times, where M=K*N, M and K are positive integers, M≥2, and K≥1. The M initial time-of-flight data corresponding to each clock period can be divided into K first initial time-of-flight data sets according to a first division manner, and each initial time-of-flight data set includes N initial time-of-flight data.

As shown in FIG. 2, the statistical unit 410 includes K statistical modules 411 connected in parallel. The K statistical modules correspond to the K first initial flight time data sets in each clock cycle in a one-to-one manner, and are used for sequentially acquiring the K first initial flight time data sets in each clock cycle in each first integration period and performing accumulation processing on the acquired initial flight time data sets to generate an accumulated flight time data set. When the K statistical modules generate S accumulated flight time data sets corresponding to the first to S first integration periods, the statistical unit 410 is further used for performing superposition processing on the S accumulated flight time data sets corresponding to the first to S first integration periods to generate a superposed flight time data set, and storing the superposed flight time data set in the memory 420.

The first division manner is a division manner of grouping every adjacent N first initial flight time data, and the M first initial flight time data corresponding to each clock cycle are divided into the K first initial flight time data sets. For example, assuming that the M first initial flight time data included in each clock cycle are sequentially represented as P0, P1, to P[M−1], the kth first initial flight time data set in each clock cycle is {P[k*N−N] to P[k*N−1]}, k is a positive integer, and 1≤k≤K, and the kth initial flight time data set corresponds to the kth statistical module of the K statistical modules of the statistical unit 410. The kth statistical module receives the kth initial flight time data set {P[k*N−N] to P[k*N−1]} of the clock cycle in any clock cycle, and performs accumulation processing on the N initial flight time data included in {P[k*N−N] to P[k*N−1]} to generate the kth accumulated photon count value of the clock cycle.

For example, the first statistical module in the statistical unit 410 is used for acquiring the first first initial flight time data set in a clock cycle, that is, the first group of first initial flight time data P0 to P[N−1], and performing accumulation processing on P0 to P[N−1] to generate the first accumulated photon count value of the clock cycle. The Kth statistical module in the statistical unit 410 is used for acquiring the Kth group of first initial flight time data P[K*N−N] to P[M−1] in a clock cycle, and performing accumulation processing on P[K*N−N] to P[M−1] to generate the Kth accumulated photon count value of the clock cycle. All the accumulated photon count values corresponding to the multiple clock cycles included in each first integration period constitute the accumulated flight time data set corresponding to the first integration period.

In the embodiment, the memory 420 includes X*M storage units, and the X*M storage units are divided into one storage module according to every M storage units. That is, the memory 420 includes X storage modules, each storage module includes M storage units, X is a positive integer, and X is greater than or equal to 1. The X*M storage units included in the memory 420 can store X*M accumulated photon count values (that is, X*N*K accumulated photon count values) at most. Correspondingly, based on the time-of-flight statistical device provided in the embodiment, the number of clock periods included in the first integration period can reach (X*M)/K=(X*N*K)/K=X*N at most, and the detection distance L1 that can be achieved by the laser ranging device within the first integration period is c*(X*N*t), where c is the speed of light, and t is the length of one clock period. Compared with another detection mode that directly samples M time-of-flight data of each clock period and then stores the M time-of-flight data in M storage units, the X*M storage units included in the memory 420 can only store time-of-flight data corresponding to X clock periods. That is, the integration period of the laser ranging device in the another detection mode includes only X clock periods, and correspondingly, the detection distance L2 that can be achieved by the laser ranging device in the another detection mode is c*(X*t), and the detection distance is smaller. The time-of-flight statistical device provided in the embodiment can extend the length of the first integration period of the laser ranging device and then increase the detection distance of the laser ranging device by performing accumulation processing on the adjacent N initial time-of-flight data, compared with the another detection mode, under the condition that the number of storage units of the memory 420 is unchanged, and meets the detection requirement of long-range detection.

In an implementation, the statistical unit 410 can perform the accumulation processing on the first to Sth first integration period corresponding accumulated time-of-flight data sets in a continuous multiple times superposition manner. For example, when the K statistical modules generate a second accumulated time-of-flight set corresponding to a second first integration period, the statistical unit 410 performs a first superposition processing on the second accumulated time-of-flight set corresponding to the second first integration period and a first accumulated time-of-flight set corresponding to a first first integration period, to obtain a first superposition time-of-flight data set. When the K statistical modules generate a third accumulated time-of-flight set corresponding to a third first integration period, the statistical unit 410 performs a second superposition processing on the third accumulated time-of-flight set corresponding to the third first integration period and the first superposition time-of-flight data set, to obtain a second superposition time-of-flight data set, and so on, until when the K statistical modules generate an Sth accumulated time-of-flight set corresponding to an Sth first integration period, the statistical unit 410 performs a superposition processing on the Sth accumulated time-of-flight data set corresponding to the Sth first integration period and an (S−1)th superposition time-of-flight data set obtained by the (S−1)th superposition processing, to obtain a superposition time-of-flight data set.

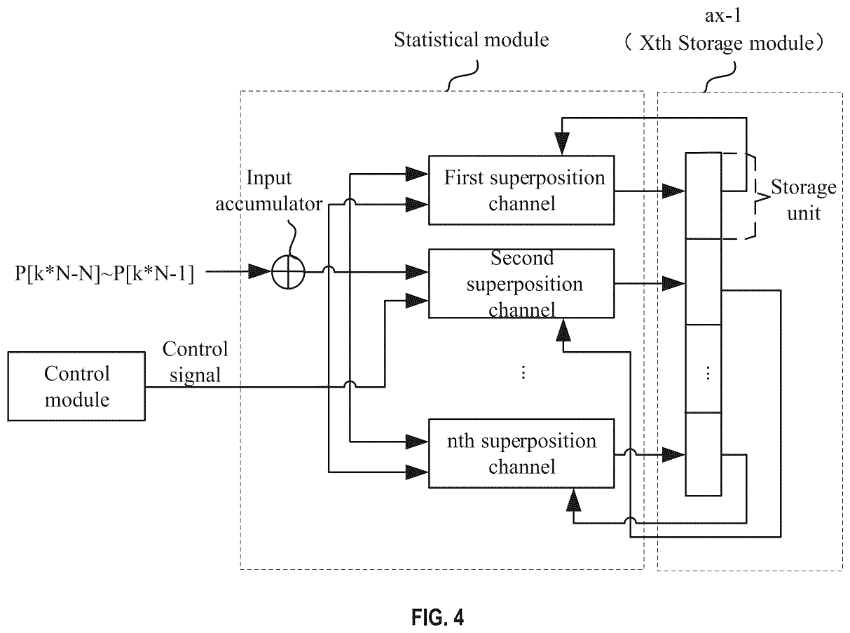

In an implementation, it is assumed that the first integration period includes X*N clock cycles. The X*N clock cycles in the first integration period are divided into X statistical periods according to every N clock cycles as a statistical period, and the X statistical periods are in one-to-one correspondence with the X storage modules in the memory. The K statistical modules in the statistical unit 410 are of the same structure. Referring to the schematic diagram of the statistical module shown in FIG. 4, each statistical module includes one input accumulator and N superposition channels connected in parallel, and the input accumulator and the N superposition channels connected in parallel are connected in series.

Specifically, the input accumulator includes N input ends and one output end, and each superposition channel includes a first superposition input end, a superposition output end, and a superposition feedback end. The N input ends of the input accumulator of each statistical module are used for acquiring an initial time-of-flight data set corresponding to the statistical module in each clock cycle of the S first integration periods, the N input ends are in one-to-one correspondence with N first initial time-of-flight data in the initial time-of-flight data set, and the output end of the input accumulator of each statistical module is connected with the N first superposition input ends of the N superposition channels.

It should be noted that the K input accumulators included in the K statistical modules are used for acquiring K initial time-of-flight data sets corresponding to each clock cycle in each first integration period in a clock cycle order, and performing accumulation processing on each initial time-of-flight data set respectively to generate an accumulated time-of-flight data set corresponding to each first integration period. The N first superposition input ends of the N superposition channels included in each statistical module of the K statistical modules are respectively connected with the output end of the corresponding input accumulator in the statistical module, and are used for acquiring an accumulated photon count value accumulated by the corresponding input accumulator in N clock cycles of each statistical period in a preset order. The N superposition output ends of the N superposition channels included in each statistical module of the K statistical modules are connected with a write end of the memory, and are used for writing data into the memory. The N superposition feedback ends of the N superposition channels included in each statistical module of the K statistical modules are connected with a readout end of the memory, and are used for reading data from the memory.

Further, as shown in FIG. 2 and FIG. 4, the time-of-flight statistics device 400 includes a control module 430 configured to output a first control signal. The K statistics modules in the statistics unit 410 are all connected to the control module 430, and the N superposition channels included in each of the K statistics modules are configured to acquire, according to the first control signal, N*K accumulated photon count values accumulated by the input accumulators in the statistics module in N clock cycles in each statistics cycle in a preset order, and store the N*K accumulated photon count values in the storage module corresponding to the statistics module.

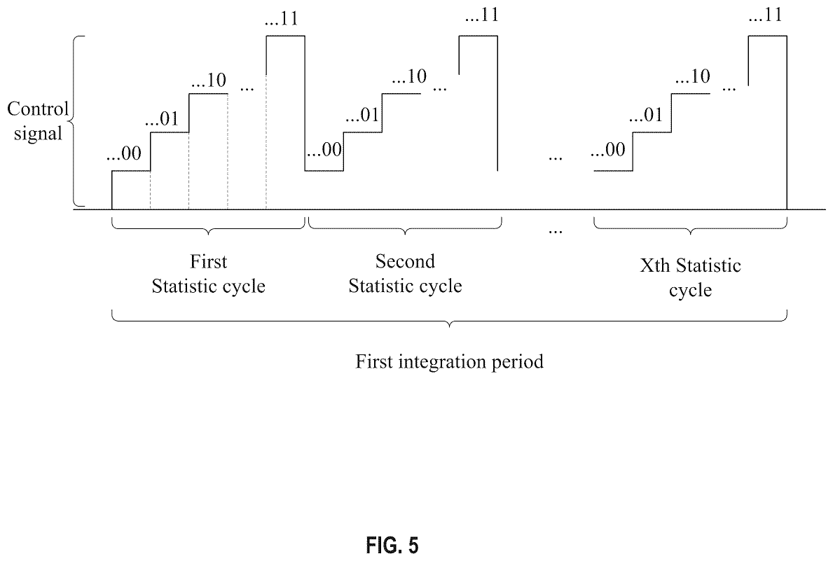

In one example, referring to a schematic diagram of the control signal output by the control module in one first integration cycle shown in FIG. 5, the first control signal is a clock cycle control signal. When the number of clock cycles in one statistics cycle is greater than 2, a plurality of first control signals can be combined by using a plurality of control signals, so that each first control signal corresponds to one clock cycle. The first superposition channel of each of the K statistics modules can acquire, according to the control signal output by the first control module, the accumulated photon count value accumulated by the corresponding input accumulator in the clock cycle corresponding to the first control signal in each statistics cycle.

For example, if one statistics cycle includes 4 clock cycles, the first control signal 00 can be used to represent the first clock cycle in the statistics cycle, the control signal 01 can be used to represent the second clock cycle in the statistics cycle, the first control signal 10 can be used to represent the third clock cycle in the statistics cycle, and the first control signal 11 can be used to represent the fourth clock cycle in the statistics cycle. Then, the first superposition channel of each of the K statistics modules acquires the accumulated photon count value accumulated by the corresponding input accumulator in the first clock cycle in each statistics cycle when the control module outputs the first control signal 00; the second superposition channel of each of the K statistics modules acquires the accumulated photon count value accumulated by the corresponding input accumulator in the second clock cycle in each statistics cycle when the control module outputs the first control signal 01; the third superposition channel of each of the K statistics modules acquires the accumulated photon count value accumulated by the corresponding input accumulator in the third clock cycle in each statistics cycle when the control module outputs the first control signal 01; and the fourth superposition channel of each of the K statistics modules acquires the accumulated photon count value accumulated by the corresponding input accumulator in the fourth clock cycle in each statistics cycle when the control module outputs the first control signal 11.

Next, referring to FIG. 4 and FIG. 5, a scheme in which the N superposition channels acquire the accumulated time-of-flight data in the N clock cycles in the preset order and store the superposed time-of-flight data set is described.

In an embodiment, the M storage units of the storage module with the storage address of ax−1 are configured to store the N*K superposed time-of-flight data obtained by superposing the S first integration periods in the xth statistical period. The K*N superposed output ends of the K statistical modules are sequentially connected to the write-in ends of the X storage modules of the memory in the order of the statistical periods in each first integration period. That is, the K*N superposed output ends of the K statistical modules are connected to the write-in end of the storage module with the storage address of ax−1 in the xth statistical period of each first integration period. The read-out ends of the X storage modules of the memory are sequentially connected to the K*N superposed feedback ends of the K statistical modules in the order of the statistical periods in each first integration period. That is, the read-out end of the storage module with the storage address of ax−1 is connected to the K*N superposed feedback ends of the K statistical modules in the xth statistical period of each first integration period.

Specifically, when the input accumulator of each statistical module generates the accumulated photon count value of the nth clock period, the first superposed input end of the nth superposed channel acquires the accumulated photon count value corresponding to the nth clock period and sends the accumulated photon count value to the superposed output end of the nth superposed channel. For example, when the input accumulator of the kth statistical module acquires the kth first initial time-of-flight data set {P[k*N−N] to P[k*N−1]} of the nth clock period and generates the kth accumulated photon count value corresponding to the nth clock period, the nth superposed channel in the kth statistical module allows the input of the kth accumulated photon count value corresponding to the nth clock period, and the other superposed channels of the N superposed channels of the kth statistical module except the nth superposed channel prohibit the input of the kth accumulated photon count value corresponding to the nth clock period. That is, the N superposed channels of each statistical module are in one-to-one correspondence with the N clock periods of each statistical period. The K*N superposed output ends of the K statistical modules are sequentially connected to the write-in ends of the X storage modules of the memory in the order of the statistical periods in each first integration period. That is, each statistical period corresponds to one storage module, and the K*N superposed output ends of the K statistical modules are connected to the write-in end of the storage module with the storage address of ax−1 in the xth statistical period of each first integration period. The read-out ends of the X storage modules of the memory are sequentially connected to the K*N superposed feedback ends of the K statistical modules in the order of the statistical periods in each first integration period. That is, the read-out end of the storage module with the storage address of ax-1 is connected to the K*N superposed feedback ends of the K statistical modules in the xth statistical period of each first integration period.

Specifically, it is assumed that each statistical module includes an input accumulator, a first superposition channel, a second superposition channel to an Nth superposition channel. The input accumulator of each statistical module includes N input ends and an output end, the N input ends of the input accumulator are respectively used to acquire a corresponding set of first initial time-of-flight data of the statistical module in each clock cycle, and the corresponding set of first initial time-of-flight data is accumulated to generate an accumulated photon count value. The input ends of the first superposition channel and the second superposition channel to the Nth superposition channel all receive the accumulated photon count value output by the output accumulator; the output ends of the first superposition channel and the second superposition channel to the Nth superposition channel are sequentially and in a time-sharing manner directed to X storage modules in the memory in the order of the X statistical cycles in the first integration period, and the output ends of the first superposition channel and the second superposition channel to the Nth superposition channel are respectively directed to N storage units of a current storage module in each statistical cycle and are respectively directed to N storage units of a next storage module in the next statistical cycle. The first superposition channel and the second superposition channel to the Nth superposition channel are sequentially turned on in the order of the N clock cycles in each statistical cycle under the action of the first control signal, so that the N accumulated photon count values generated by the input accumulator in each statistical cycle are stored in the N storage units of the current storage module. The first superposition channel and the second superposition channel to the Nth superposition channel are further used to repeatedly perform the sequentially turning-on operation X times in the order of the X statistical cycles in the first integration period, so that X*N accumulated photon count values generated by the input accumulator in the X statistical cycles included in the first integration period are respectively stored in the N storage units of the X storage modules.

It should be noted that the structure of each statistical module in the K statistical modules is the same. The structure and function of each statistical module are exemplarily described below by taking a kth statistical module in the K statistical modules as an example.

Specifically, the input accumulator included in the kth statistical module is used for acquiring the kth group of first initial flight time data {P[k*N−N] to P[k*N−1]} in each clock cycle, and performing accumulation processing on N first initial flight time data {P[k*N−N] to P[k*N−1]} in the kth group of first initial flight time data to generate a kth accumulated photon count value of each clock cycle. The first superposition channel included in the kth statistical module is turned on in the first clock cycle of each statistical cycle to store the kth accumulated photon count value generated by the input accumulator in the first clock cycle of the statistical cycle in the kth storage unit of the current storage module corresponding to the statistical cycle; the nth superposition channel included in the kth statistical module is turned on in the nth clock cycle of each statistical cycle to store the kth accumulated photon count value generated by the input accumulator in the nth clock cycle of the statistical cycle in the nth storage unit of the current storage module; and the Nth superposition channel included in the kth statistical module is turned on in the nth clock cycle of each statistical cycle to store the kth accumulated photon count value generated by the input accumulator in the Nth clock cycle of the statistical cycle in the Nth storage unit of the current storage module, where n is a positive integer and 1≤n≤N.

In the embodiment of the application, the time-of-flight statistical device sequentially turns on the first superposition channel, the second superposition channel to the Nth superposition channel according to the order of the N clock cycles of each statistical cycle in each statistical module, to realize accumulation sampling and storage of the first initial flight time data corresponding to each statistical cycle, and to ensure that the statistics of the first initial flight time data of each clock cycle do not interfere with each other. Meanwhile, the time-of-flight statistical device sequentially turns on the first superposition channel, the second superposition channel to the Nth superposition channel X times repeatedly, to realize accumulation sampling and storage of the first initial flight time data corresponding to each first integration cycle, without increasing the number of superposition channels, and with a simple structure.

Further, after the kth statistical module completes the accumulated sampling of the kth set of first initial time-of-flight data {P[k*N−N] to P[k*N−1]} of the N clock periods included in the current statistical period and stores the kth accumulated photon count value corresponding to the N clock periods in the N storage units of the currently pointed storage module corresponding to the current statistical period, the kth statistical module continues to complete the accumulated sampling of the kth set of first initial time-of-flight data {P[k*N−N] to P[k*N−1]} of the N clock periods included in the next statistical period and stores the kth accumulated photon count value corresponding to the N clock periods in the N storage units of the next pointed storage module, until the accumulated sampling of the kth set of first initial time-of-flight data {P[k*N−N] to P[k*N−1]} of the X*N clock periods included in the X statistical periods included in the first integration period is completed and the X*N kth accumulated photon count values corresponding to the X*N clock periods are stored in the X*N storage units of the X storage modules.

It can be understood that after the K statistical modules complete the accumulated sampling of the K sets of first initial time-of-flight data {P0 to P[N−1]}, . . . , {P[k*N−N] to P[k*N−1]}, . . . , {P[K*N−N] to P[K*N−1]} of the N clock periods included in the current statistical period and store the N*K accumulated photon count values of the N clock periods in the N*K storage units (i.e., M storage units) of the currently pointed storage module, the K statistical modules continue to complete the accumulated sampling of the K sets of first initial time-of-flight data {P0 to P[N−1]}, . . . , {P[k*N−N] to P[k*N−1]}, . . . , {P[K*N−N] to P[K*N−1]} of the N clock periods included in the next statistical period and store the N*K accumulated photon count values of the N clock periods in the N*K storage units (i.e., M storage units) of the next pointed storage module, until the accumulated sampling of the K sets of first initial time-of-flight data {P0 to P[N−1]}, . . . , {P[k*N−N] to P[k*N−1]}, . . . , {P[K*N−N] to P[K*N−1]} of the X*N clock periods included in the X statistical periods included in the first integration period is completed and the X*N*K accumulated photon count values corresponding to the X*N clock periods are stored in the X*N*K (i.e., X*M) storage units of the X storage modules.

In an example, assuming that M=4, N=2, K=2, the time-of-flight statistical device includes two statistical modules, i.e., a first statistical module and a second statistical module; the number of superposition channels included in each statistical module is two, i.e., a first superposition channel and a second superposition channel; the number of clock cycles included in each statistical cycle is two, the number of statistical cycles included in each integration cycle is X, the number of clock cycles included in each statistical cycle is two, and the number of storage units included in each storage module is four.

When the first statistical module and the second statistical module obtain two groups of first initial time-of-flight data {P0, P1} and {P2, P3} of the first clock cycle of the xth statistical cycle, x is a positive integer, and 1≤x≤X, the input accumulators of the first statistical module and the second statistical module respectively accumulate the two groups of first initial time-of-flight data {P0, P1} and {P2, P3} input in the first clock cycle of the xth statistical cycle, to generate a first accumulated photon count value P01=P0+P1 and a second accumulated photon count value P23=P2+P3 corresponding to the first clock cycle, the first superposition channel in the first statistical module and the first superposition channel in the second statistical module allow the first accumulated photon count value P01 and the second accumulated photon count value P23 of the first clock cycle to be input under the action of the control signal, the second superposition channel in the first statistical module and the second superposition channel in the second statistical module prohibit the first accumulated photon count value and the second accumulated photon count value of the first clock cycle from being input under the action of the control signal, and the first accumulated photon count value P01 and the second accumulated photon count value P23 corresponding to the first clock cycle are respectively stored into two storage units of the storage module corresponding to the storage address ax−1 of the xth statistical cycle through the first superposition channels respectively turned on by the first statistical module and the second statistical module.

Further, when the first statistical module and the second statistical module acquire the two groups of first initial flight time data {P0, P1} and {P2, P3} of the second clock cycle of the xth statistical cycle, the input accumulators of the first statistical module and the second statistical module respectively accumulate the two groups of first initial flight time data {P0, P1} and {P2, P3} input in the second clock cycle of the xth statistical cycle, to generate the first accumulated photon count value and the second accumulated photon count value corresponding to the second clock cycle, the first superposition channel in the first statistical module and the first superposition channel in the second statistical module inhibit the input of the first accumulated photon count value and the second accumulated photon count value of the second clock cycle under the action of the control signal, the second superposition channel in the first statistical module and the second superposition channel in the second statistical module allow the input of the first accumulated photon count value and the second accumulated photon count value of the second clock cycle under the action of the control signal, and the first accumulated photon count value and the second accumulated photon count value corresponding to the second clock cycle are respectively stored into the other two storage units of the storage module with the storage address ax−1 corresponding to the xth statistical cycle through the second superposition channels respectively turned on by the first statistical module and the second statistical module.

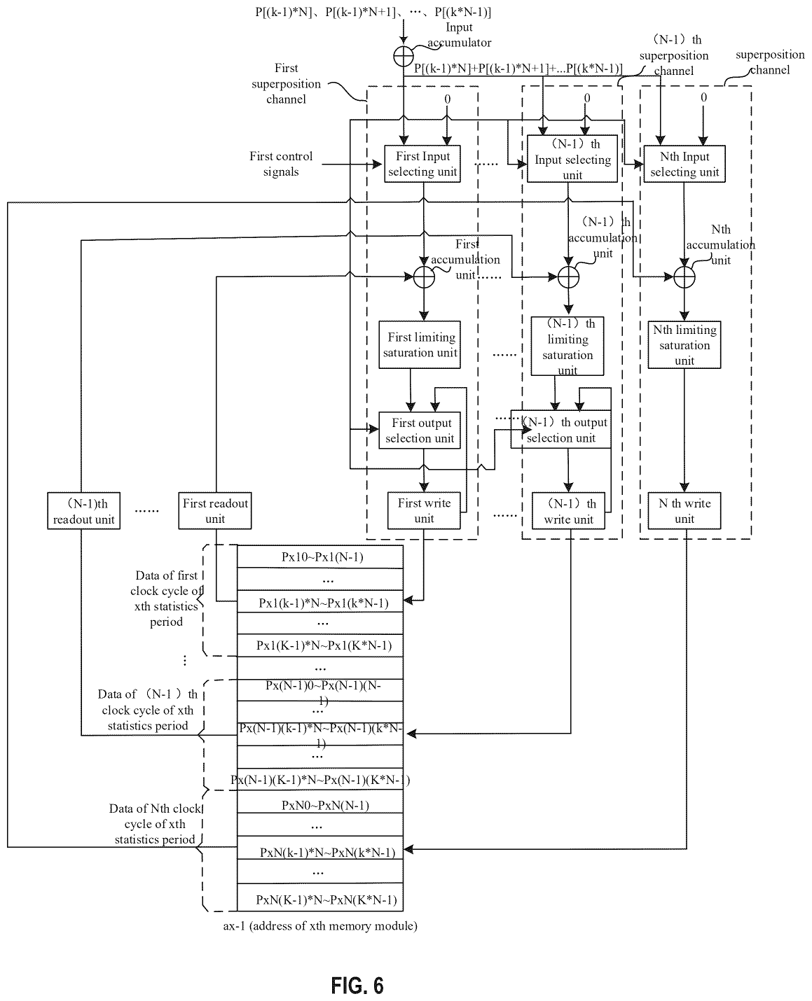

In the embodiment, the structures of the first superposition channel to the (N−1)th superposition channel in each statistical module are the same, and the structure of the Nth superposition channel in each statistical module is different from the structures of the first N−1 superposition channels. The specific structure of the first N superposition channels in each statistical module is exemplarily described below with reference to a structural schematic diagram of a kth statistical module in the K statistical modules shown in FIG. 6, taking the first N−1 superposition channels (i.e., the nth superposition channel in the first superposition channel to the (N−1)th superposition channel) of the kth statistical module as an example, where n is a positive integer, and 1≤n≤N−1.

In an implementation, the nth superposition channel of each statistical module includes an nth input selection unit, an nth accumulation unit, an nth limit saturation unit, an nth output selection unit, an nth writing unit, and an nth reading unit.

Specifically, the nth input selection unit includes two input terminals, one output terminal and one control terminal, one of the input terminals is connected with the output terminal of the input accumulator in the kth statistical module, the other input terminal receives data 0, the output terminal is connected with one input terminal of the nth accumulation unit, and the control terminal is connected with the output terminal of the control module; the nth accumulation unit includes two input terminals and one output terminal, one input terminal is connected with the output terminal of the nth input selection unit, and the output terminal is connected with the input terminal of the nth limiting saturation unit; the nth limiting saturation unit includes one input terminal and one output terminal, the input terminal is connected with the output terminal of the nth accumulation unit, and the output terminal is connected with one input terminal of the nth output selection unit; the nth output selection unit includes two input terminals, one output terminal and one control terminal, one of the input terminals is connected with the output terminal of the nth limiting saturation unit, the other input terminal is connected with one output terminal of the nth write unit, the output terminal is connected with the input terminal of the nth write unit, and the control terminal is connected with the output terminal of the control module; the nth write unit includes one input terminal and two output terminals, the input terminal is connected with the output terminal of the nth output selection unit, one of the output terminals is connected with the other input terminal of the nth output selection unit, and the other output terminal is connected with the memory; and the nth read unit includes one input terminal and one output terminal, the input terminal is connected with the memory, and the output terminal is connected with the other input terminal of the nth accumulation unit.

Referring to FIG. 6, in one implementation, the Nth superposition channel in each statistical module includes an Nth input selection unit, an Nth accumulation unit, an Nth limiting saturation unit, an Nth write unit and an Nth read unit.

Specifically, the Nth input selection unit includes two input terminals, one output terminal and one control terminal, one of the input terminals is connected with the output terminal of the input accumulator of the kth statistical module, the other input terminal receives data 0, the output terminal is connected with one input terminal of the Nth accumulation unit, and the control terminal is connected with the output terminal of the control module; the Nth accumulation unit includes two input terminals and one output terminal, one input terminal is connected with the output terminal of the Nth input selection unit, and the output terminal is connected with the input terminal of the Nth limiting saturation unit; the Nth limiting saturation unit includes one input terminal and one output terminal, the input terminal is connected with the output terminal of the Nth accumulation unit, the output terminal is connected with the input terminal of the Nth write unit, and the control terminal is connected with the output terminal of the control module; the Nth write unit includes one input terminal and one output terminal, the input terminal is connected with the output terminal of the Nth limiting saturation unit, and the output terminal is connected with the memory; and the Nth read unit includes one input terminal and one output terminal, the input terminal is connected with the memory, and the output terminal is connected with the other input terminal of the Nth accumulation unit.

In an example, if N=2, that is, the number of superposition channels included in each statistical module is two, each first integration period includes X statistical periods, and the number of clock periods included in each statistical period is two, that is, the number of clock periods included in each first integration period is 2*X. Then, for S first integration periods, where S is the number of times that the laser emission module emits pulsed laser in a time frame and is also the number of times that the laser receiving module receives echo laser in a time frame, the specific working process of the first superposition channel to the Nth superposition channel of the K statistical modules in the S first integration periods includes the following steps:

Step s1x1: the input accumulators of the K statistical modules respectively acquire K groups of first initial flight time data {P0 to P[N−1]}, . . . , {P[k*N−N] to P[k*N−1]}, . . . , {P[K*N−N] to P[K*N−1]} in the first clock period of the xth statistical period in the first first integration period of the S first integration periods, and perform accumulation processing on the K groups of first initial flight time data {P0 to P[N−1]}, . . . , {P[k*N−N] to P[k*N−1]}, . . . , {P[K*N−N] to P[K*N−1]}, where x is a positive integer, and 1<x≤X, to generate K accumulated photon count values in the first clock period; the first input selection units of the K statistical modules allow the K accumulated photon count values accumulated by the corresponding K input accumulators in the first clock period to pass through and be output under the action of the first control signal output by the control module; the second input selection unit to the Nth input selection unit of the K statistical modules do not allow the K accumulated photon count values accumulated by the K input accumulators in the first clock period to pass through under the action of the control signal output by the control module, but allow data 0 to pass through and be output; the K accumulated photon count values output by the K first input selection units pass through the first accumulation unit of the first superposition channel in sequence and are output to the first limiting saturation unit of the first superposition channel, the first limiting saturation unit is used for limiting the bit width of the accumulated flight time corresponding to the accumulated photon count value that can pass through, if the bit width of the accumulated flight time corresponding to the accumulated photon count value input to the first limiting saturation unit does not exceed the limit bit width of the first limiting saturation unit, the first limiting saturation unit allows the accumulated photon count value to pass through and be output to the first output selection unit, and the first output selection unit allows the accumulated photon count value to pass through and be output to the first write unit in the first superposition channel under the control of the control signal output by the control module; if the bit width of the accumulated flight time in the accumulated photon count value input to the first limiting saturation unit exceeds the limit bit width of the first limiting saturation unit, the first limiting saturation unit does not allow the accumulated photon count value to pass through.

In the step s1x2, the input accumulators of the K statistical modules respectively acquire K groups of first initial flight time data {P0 to P[N−1]}, {P[k*N−N] to P[k*N−1]}, . . . , {P[K*N−N] to P[K*N−1]} in the second clock cycle of the xth statistical cycle of the first first integration cycle, and perform accumulation processing on the K groups of first initial flight time data {P0 to P[N−1]}, {P[k*N−N] to P[k*N−1]}, . . . , {P[K*N−N] to P[K*N−1]} to generate K accumulated photon count values in the first clock cycle; the first input selection units of the K statistical modules, under the action of the first control signal output by the control module, prohibit the K accumulated photon count values obtained by the K input accumulators in the first clock cycle from passing through, and instead allow data 0 to pass through and be output; the second input selection unit to the Nth input selection unit of the K statistical modules, under the action of the control signal output by the control module, allow the K accumulated photon count values obtained by the corresponding K input accumulators in the first clock cycle to pass through and be output; the K accumulated photon count values output by the K first input selection units pass through the second accumulation units of the second superposition channels in sequence and are output to the second limiting saturation units of the second superposition channels; the second limiting saturation units are used for limiting the bit width of the accumulated flight time in the accumulated photon count values that can pass through; if the bit width of the accumulated flight time in the accumulated photon count values input to the second limiting saturation units does not exceed the limited bit width of the second limiting saturation units, the second limiting saturation units allow the accumulated photon count values to pass through and be output to the second output selection units; under the control of the control signal output by the control module, the second output selection units allow the accumulated photon count values to pass through and be output to the second write-in units in the second superposition channels; if the bit width of the accumulated flight time in the accumulated photon count values input to the second limiting saturation units exceeds the limited bit width of the second limiting saturation units, the second limiting saturation units prohibit the accumulated photon count values from passing through.

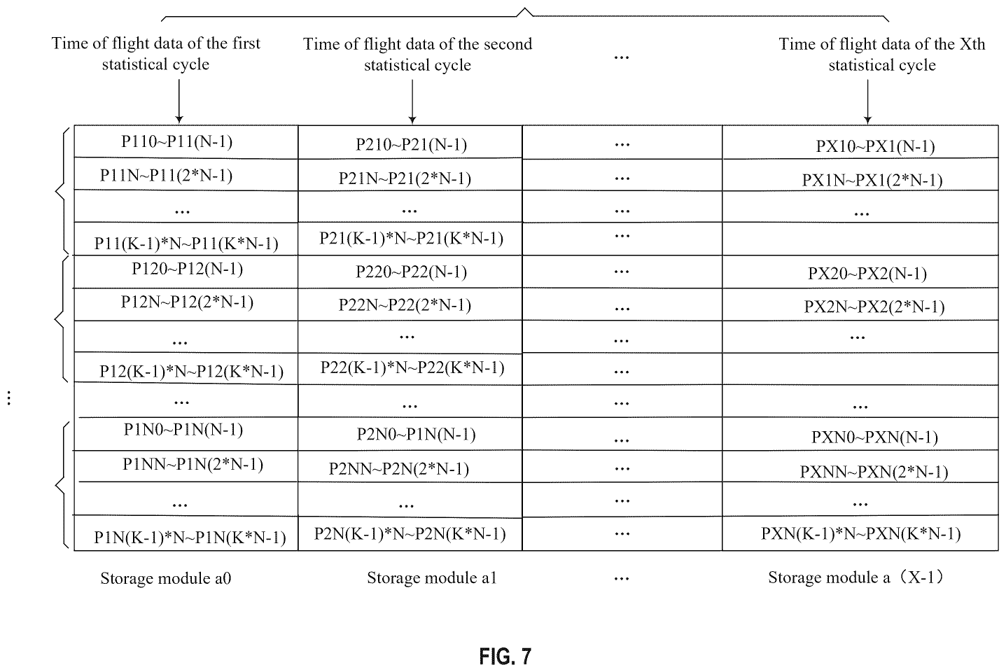

Step s1x3: when the first writing unit to the Nth writing unit of the K statistical modules store the N*K accumulated photon count values accumulated by the K input accumulators in the xth statistical period of the first first integration period in the N*K storage units (i.e. M storage units) of the current storage module (i.e. the x−1 storage module corresponding to the xth statistical period), the first writing unit to the Nth writing unit of the K statistical modules point to the next storage module (i.e. the xth storage module), the input accumulators of the K statistical modules continue to acquire the N*K sets of first initial flight time data of the (x+1)th statistical period of the first first integration period, and the first superposition channel to the second superposition channel of the K statistical modules repeat the above step s1x1 and step s1x2 for X times, until the first superposition channel to the second superposition channel of the K statistical modules sequentially complete the steps S111, S112, . . . . S1x1, S1x2, . . . , to S1X1, S1X2 in the X statistical periods of the first first integration period. Referring to the storage diagram of the flight time data in the first integration period shown in FIG. 7, the first superposition channel to the second superposition channel of the K statistical modules sequentially complete the accumulated sampling of the K sets of first initial flight time data {P0 to P[N−1]}, . . . , {P[k*N−N] to P[k*N−1]}, . . . , {P[K*N−N] to P[K*N−1]} in each clock cycle of the X*N clock cycles of the X statistical periods of the first first integration period, and store the obtained X*N*K accumulated photon count values corresponding to the X*N clock cycles in the X*N*K storage units (i.e. X*M storage units) of the X storage modules, thereby completing the accumulated sampling and storage of the first initial flight time data of the X statistical periods of the first first integration period.

It is to be understood that, in the embodiment, before the end of the Nth clock cycle of each statistical period, the nth output selection unit of the K statistical modules continuously outputs the accumulated photon count value obtained by the corresponding input accumulator to the respective first writing unit, so that when the Nth clock cycle of each statistical period arrives and the Nth writing unit of the K statistical modules obtains the K accumulated photon count values obtained by the K input accumulators in the Nth clock cycle of each statistical period, the n writing unit of the K statistical modules can obtain the K accumulated photon count values obtained by the K input accumulators in the n clock cycle of each statistical period, that is, the first writing unit to the Nth writing unit of the K statistical modules obtain the N*K accumulated photon count values obtained by the K input accumulators in the N clock cycles of each statistical period. When the first writing unit to the Nth writing unit of the K statistical modules obtain the N*K accumulated photon count values obtained by the K input accumulators in each statistical period, the first writing unit to the Nth writing unit of the K statistical modules perform a writing operation to write the N*K accumulated photon count values obtained by the K input accumulators in each statistical period into the currently pointed storage module.

For example, after the accumulation sampling and storage of all the first initial time-of-flight data of the X statistical periods in the first of the S first integration periods are completed based on the steps s1x1 to s1x3, when the first superposition channel to the second superposition channel of the K statistical modules enter the second of the first integration periods, the accumulated photon count values of the same accumulated flight moment in the first of the first integration periods are read from the storage in sequence and output to the first accumulation unit to the Nth accumulation unit of the K statistical modules, so that the accumulated photon count values of the same accumulated flight moment in the first of the first integration periods and the second of the first integration periods are superposed for the first time to obtain a first superposed time-of-flight data set, and the X*N*K first superposed photon count values corresponding to the X*N clock cycles are stored in the X*N*K storage units of the X storage modules. Specifically, the method includes the following steps:

Step one: in a first statistical period of the second first integration period, the first write unit and the Nth write unit of the K statistical modules are directed to the write end of the first storage module in the storage module, the first read unit and the Nth read unit of the K statistical modules are directed to the read end of the first storage module in the storage module, and the first read unit and the Nth read unit read the K accumulated photon count values of each clock cycle in the first statistical period of the first first integration period and output the K accumulated photon count values to the first accumulation unit to the Nth accumulation unit of the K statistical modules, so that the first accumulation unit to the Nth accumulation unit superimposes the N*K accumulated photon count values obtained by accumulation in the first statistical period of the second first integration period and the N*K accumulated photon count values obtained by accumulation in the first statistical period of the second first integration period, and under the control of the control signal, the N*K superimposed photon count values corresponding to the first statistical period obtained after superimposition are sequentially output to the first write unit to the Nth write unit through the first limiting saturation unit to the Nth limiting saturation unit and the first output selection unit to the (N−1)th output selection unit in the K statistical modules, and the first write unit to the Nth write unit stores the N*K superimposed photon count values in the first storage module of the memory.

Step two: in a second statistical period of the second first integration period, the first write unit and the Nth write unit of the K statistical modules are directed to the write end of the second storage module in the storage module, the first read unit and the Nth read unit of the K statistical modules are directed to the read end of the second storage module in the storage module, and the first read unit and the Nth read unit read the K accumulated photon count values of each clock cycle in the second statistical period of the first first integration period and output the K accumulated photon count values to the first accumulation unit to the Nth accumulation unit of the K statistical modules, so that the first accumulation unit to the Nth accumulation unit superimposes the N*K accumulated photon count values obtained by accumulation in the second statistical period of the second first integration period and the N*K accumulated photon count values obtained by accumulation in the second statistical period of the second first integration period, and outputs the N*K superimposed photon count values corresponding to the second statistical period obtained after superimposition to the first write unit to the Nth write unit, and the first write unit to the Nth write unit stores the N*K superimposed photon count values corresponding to the second statistical period in the second storage module of the memory.

Step three: the first superposition channel to the Nth superposition channel of the K statistical modules repeat the above step one and step two for X times, until the first superposition channel to the second superposition channel of the K statistical modules sequentially complete the first superposition of the N*K superposed photon count values in the X statistical periods of the first first integration period and the N*K superposed photon count values in the X statistical periods of the second first integration period, to obtain the first superposed time-of-flight data set, and store the X*N*K superposed photon count values corresponding to the X*N clock cycles obtained by the first superposition in the X*N*K storage units (i.e. X*M storage units) of the X storage modules, to complete the accumulation sampling of the initial time-of-flight data of the X statistical periods of the second first integration period, and simultaneously complete the first superposition and storage of the accumulated photon count values at the same accumulation flight moment in the first first integration period and the second first integration period.

Step four: based on the above steps one to three, when the first superposition channel to the second superposition channel of the K statistical modules enter the third first integration period, the first superposition channel to the Nth superposition channel in the K statistical modules repeat the above steps one to three. That is, the first readout unit to the Nth readout unit in the K statistical modules sequentially read the superposed photon count values at the same accumulation flight moment in the first superposed time-of-flight data set stored in the memory, and output to the first accumulation unit to the Nth accumulation unit of the K statistical modules, to perform the second superposition on the first superposed photon count values in the first superposed time-of-flight data set obtained by the first superposition and the accumulated photon count values at the same accumulation flight moment in the third first integration period, to obtain the second superposed time-of-flight data set, and store the X*N*K second superposed photon count values corresponding to the X*N clock cycles in the X*N*K storage units of the X storage modules. By analogy, when the first superposition channel to the second superposition channel of the K statistical modules enter the Sth first integration period, the first readout unit to the Nth readout unit in the K statistical modules sequentially read the superposed photon count values at the same accumulation flight moment in the (S−1)th superposed time-of-flight data set stored in the memory, and output to the first accumulation unit to the Nth accumulation unit of the K statistical modules, to perform the S−1 superposition on the S−1 superposed photon count values in the (S−1)th superposed time-of-flight data set obtained by the S−2 superposition and the accumulated photon count values at the same accumulation flight moment in the Sth first integration period, to obtain the S−1 superposed time-of-flight data set, and store the X*N*K S−1 superposed photon count values corresponding to the X*N clock cycles in the X*N*K storage units of the X storage modules, so as to realize the superposition of the accumulated photon count values at the same accumulation flight moment in the S first integration periods.

In an implementation, the nth input selection unit in each statistical module includes an nth data selector MUXn, which is a 2-to-1 data selector. The nth data selector MUXn includes two data input terminals, one data output terminal, and one selection input terminal. One data input terminal of the nth data selector MUXn is connected to the output terminal of the corresponding input accumulator, the other data input terminal receives data 0, the data output terminal is connected to one input terminal of the corresponding nth accumulator, and the selection input terminal is connected to the signal output terminal of the control module. Under the action of the first control signal, the nth data selector MUXn selects and outputs the accumulated photon count value obtained by the corresponding input accumulator in the nth clock cycle of each statistical period, and inhibits the accumulated photon count value obtained in other clock cycles of the N clock cycles in each statistical period from being output, except for the nth clock cycle. When the nth data selector MUXn inhibits the accumulated photon count value obtained in other clock cycles of the N clock cycles in each statistical period from being output, except for the nth clock cycle, under the action of the first control signal, the nth data selector MUXn selects and outputs data.

In an implementation, the nth output selection unit in each statistical module includes a data selector MUX_n, which is a 2-to-1 data selector. The data selector MUX_n includes two data input terminals, one data output terminal, and one selection input terminal. One data input terminal of the data selector MUX_n is connected to the output terminal of the nth limiting saturation unit, the other data input terminal is connected to the output terminal of the nth write-in unit, the data output terminal is connected to the input terminal of the nth write-in unit, and the selection input terminal is connected to the control signal output terminal of the control module.

When the K input accumulators obtain the first initial flight time data in the nth clock cycle of each statistical period, the nth data selector MUXn corresponding to the nth input selection unit selects and inputs the accumulated photon count value obtained by the corresponding input accumulator in the nth clock cycle of each statistical period under the action of the first control signal. If the accumulated photon count value does not exceed the limited bit width of the nth limiting saturation unit, the nth data selector MUX_n corresponding to the nth output selection unit selects and obtains the data output by the nth limiting saturation unit under the action of the first control signal, and outputs the data to the nth write-in unit. When the K input accumulators obtain the initial flight time data in the non-nth clock cycle of each statistical period, the nth data selector MUXn corresponding to the nth input selection unit selects and inputs data 0 under the action of the first control signal, and the data selector MUX_n corresponding to the nth output selection unit selects and obtains the data temporarily stored in the nth write-in unit under the action of the control signal, and outputs the data to the nth write-in unit again.

When the K input accumulators obtain the first initial time-of-flight data in the Nth clock cycle of each statistical period, a data selector MUXN corresponding to the Nth input selection unit selects an accumulated photon count value obtained by the corresponding input accumulator in the Nth clock cycle of each statistical period under the action of the first control signal.

When the Nth writing unit of the K statistical modules acquires the accumulated photon count value, the first writing unit to the Nth writing unit of the K statistical modules perform a writing operation once, and write the N*K accumulated photon count values obtained by the K input accumulators in each statistical period into the currently pointed storage module

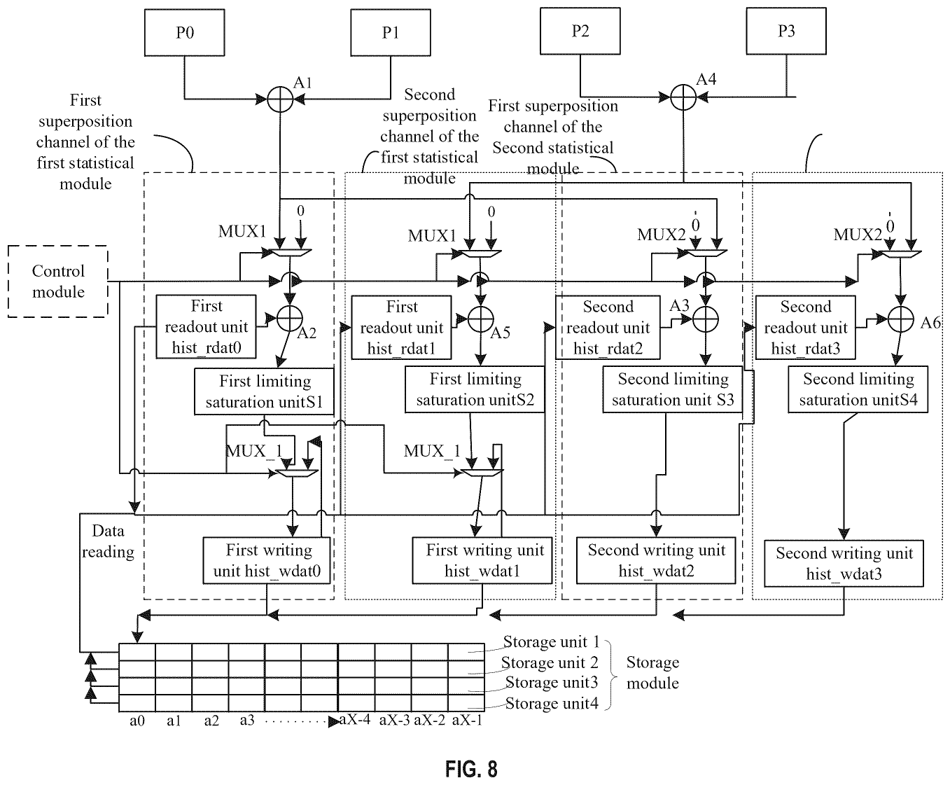

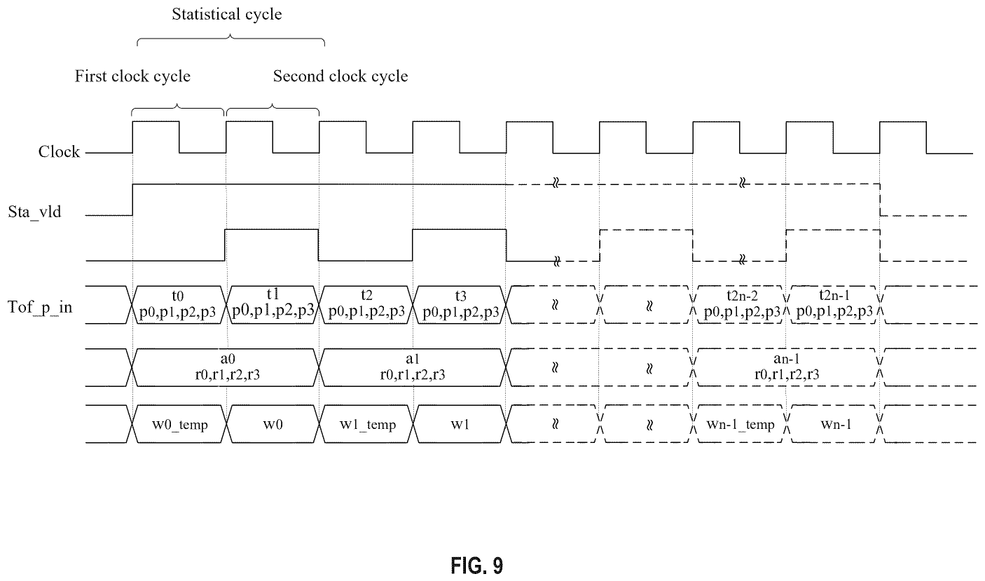

By way of example but not limitation, with reference to the specific structure schematic diagram of the time-of-flight statistical device shown in FIG. 8 and the timing diagram of the first integration period shown in FIG. 9, it is assumed that M=4, N=2, and K=2; the time-of-flight statistical device includes two statistical modules, i.e., a first statistical module and a second statistical module, each of which includes two superposition channels; each statistical period includes two clock periods, i.e., a first clock period and a second clock period; each first integration period includes 2*X clock periods; and each storage module includes four storage units.

(1) When the first statistical module and the second statistical module acquire two groups of first initial time-of-flight data {P0, P1} and {P2, P3} of the first clock period of the xth statistical period:

The input accumulator A1 of the first statistical module and the input accumulator A4 of the second statistical module respectively accumulate two groups of first initial time-of-flight data {P0, P1} and {P2, P3} input in the first clock cycle of the xth statistical cycle to generate a first accumulated photon count value P01 and a second accumulated photon count value P23 corresponding to the first clock cycle. Under the action of the first control signal, the first data selector MUX1 corresponding to the first input selection unit of the first statistical module selects the first accumulated photon count value P01 input corresponding to the first clock cycle. If the first accumulated photon count value P01 corresponding to the first clock cycle does not exceed the limit bit width of the first limiting saturation unit included in the first statistical module, under the action of the first control signal, the data selector MUX_1 corresponding to the first output selection unit of the first statistical module selects the data output by the first limiting saturation unit included in the first statistical module. That is, the first accumulated photon count value P01, and outputs the first accumulated photon count value P01 to the first write unit hist_wdat0 of the first statistical module. Under the action of the first control signal, the first data selector MUX1 corresponding to the first input selection unit of the second statistical module selects the second accumulated photon count value P23 input corresponding to the first clock cycle. Under the action of the first control signal, the data selector MUX1 corresponding to the first input selection unit of the second statistical module selects the second accumulated photon count value P23 input corresponding to the first clock cycle. If the second accumulated photon count value P23 corresponding to the first clock cycle does not exceed the limit bit width of the first limiting saturation unit included in the second statistical module, under the action of the first control signal, the data selector MUX_1 corresponding to the first output selection unit of the second statistical module selects the data output by the first limiting saturation unit included in the second statistical module. That is, the second accumulated photon count value P23, and outputs the second accumulated photon count value P23 to the first write unit hist_wdat1 of the second statistical module.

(2) When the first statistical module and the second statistical module obtain two groups of first time-of-flight data {P0, P1} and {P2, P3} in the second clock cycle of the xth statistical cycle:

The input accumulator A1 of the first statistical module and the input accumulator A4 of the second statistical module respectively accumulate two groups of first initial time-of-flight data {P0, P1} and {P2, P3} input in the second clock cycle of the xth statistical cycle to generate a first accumulated photon count value P01 and a second accumulated photon count value P23 corresponding to the second clock cycle. Under the action of the first control signal, the data selector MUX1 corresponding to the first input selection unit of the first statistical module allows the data 0 to pass through and be output, and under the action of the first control signal, the data selector MUX_2 corresponding to the first output selection unit of the first statistical module allows the data temporarily stored by the first write unit of the first statistical module to pass through and be output. That is, the first accumulated photon count value P01 corresponding to the first clock cycle is output to the first write unit of the first statistical module. Under the action of the first control signal, the data selector MUX2 corresponding to the second input selection unit of the first statistical module selects the first accumulated photon count value P01 corresponding to the second clock cycle, and if the first accumulated photon count value P01 corresponding to the second clock cycle does not exceed the limit bit width of the second limiting saturation unit included in the first statistical module, the second limiting saturation unit included in the first statistical module outputs the first accumulated photon count value P01 corresponding to the second clock cycle. Under the action of the first control signal, the data selector MUX_1 corresponding to the second output selection unit of the first statistical module acquires the data output by the second limiting saturation unit included in the first statistical module. That is, the first accumulated photon count value P01 corresponding to the second clock cycle, and outputs the data to the second write unit hist_wdat2 of the first statistical module. Under the action of the control signal, the data selector MUX1 corresponding to the first input selection unit of the second statistical module allows the data 0 to pass through and be output, and under the action of the control signal, the data selector MUX_2 corresponding to the first output selection unit of the second statistical module allows the data temporarily stored by the first write unit of the second statistical module. That is, the second accumulated photon count value P23 corresponding to the first clock cycle, to pass through and be output to the first write unit of the second statistical module. Under the action of the control signal, the data selector MUX1 corresponding to the second input selection unit of the second statistical module selects the second accumulated photon count value P23 corresponding to the second clock cycle, and if the second accumulated photon count value P23 corresponding to the second clock cycle does not exceed the limit bit width of the second limiting saturation unit included in the second statistical module, the second limiting saturation unit included in the second statistical module outputs the second accumulated photon count value P23 corresponding to the second clock cycle. Under the action of the first control signal, the data selector MUX2 corresponding to the second output selection unit of the second statistical module acquires the data output by the second limiting saturation unit included in the second statistical module, that is, the second accumulated photon count value P23 corresponding to the second clock cycle, and outputs the data to the second write unit hist_wdat3 of the second statistical module.

At this time, the first write unit of the first statistical module temporarily stores the first accumulated photon count value P01 corresponding to the first clock cycle, and the first write unit of the second statistical module temporarily stores the second accumulated photon count value P23 corresponding to the first clock cycle; the second write unit of the first statistical module temporarily stores the first accumulated photon count value P01 corresponding to the second clock cycle, and the second write unit of the second statistical module temporarily stores the second accumulated photon count value P23 corresponding to the second clock cycle; the first write unit and the second write unit of the first statistical module and the first write unit and the second write unit of the second statistical module write the four accumulated photon count values (i.e. the first accumulated photon count value P01, the second accumulated photon count value P23 corresponding to the first clock cycle of the xth statistical cycle and the first accumulated photon count value P01, the second accumulated photon count value P23 corresponding to the second clock cycle of the xth statistical cycle) obtained by the input accumulators of the two statistical modules in the two clock cycles of the xth statistical cycle into the storage module with the storage address ax−1 corresponding to the xth statistical cycle.

In the embodiment, after the storage module with the storage address ax−1 is written with the four accumulated photon count values corresponding to the xth statistical cycle by the two statistical modules, and x<X, the first write unit, the second write unit of the first statistical module and the first write unit, the second write unit of the second statistical module point to the storage module with the storage address ax corresponding to the (x+1)th statistical cycle, and the first statistical module and the second statistical module continue to perform the accumulated sampling of the initial flight time data of the (x+1)th statistical cycle of the current first integration cycle and store the initial flight time data into the storage module with the storage address ax;

after the storage module with the storage address aX−1 is written with the four accumulated photon count values corresponding to the Xth statistical cycle by the two statistical modules, that is, after the first statistical module and the second statistical module complete the accumulated sampling and storage of the initial flight time data of the current first integration cycle, the control module stops outputting the control signal until the next first integration cycle comes, and the control module performs the accumulated sampling and storage of the initial flight time data of the X statistical cycles in the first integration cycle again.

It should be noted that when the statistical unit performs the operation of the next first integration period, the first readout unit of the first statistical module is configured to read and output the first accumulated photon count value P01 corresponding to the first clock period of the xth statistical period of the previous first integration period to the first accumulation unit of the first statistical module in the xth statistical period of the next first integration period; the first readout unit of the second statistical module is configured to read and output the second accumulated photon count value P23 corresponding to the first clock period of the xth statistical period of the previous first integration period to the first accumulation unit of the second statistical module in the xth statistical period of the next first integration period; the second readout unit of the first statistical module is configured to read and output the first accumulated photon count value P01 corresponding to the second clock period of the xth statistical period of the previous first integration period to the second accumulation unit of the first statistical module in the xth statistical period of the next first integration period; and the second readout unit of the second statistical module is configured to read and output the second accumulated photon count value P23 corresponding to the second clock period of the xth statistical period of the previous first integration period to the second accumulation unit of the second statistical module in the xth statistical period of the next first integration period, so as to realize superposition of the histogram data corresponding to a plurality of first integration periods, until the input accumulators of the K statistical modules complete accumulation sampling of the initial time-of-flight data of the Sth first integration period, and the K statistical modules complete superposition of the histogram data corresponding to all the first integration periods, to generate the final histogram data.

### Embodiment Two

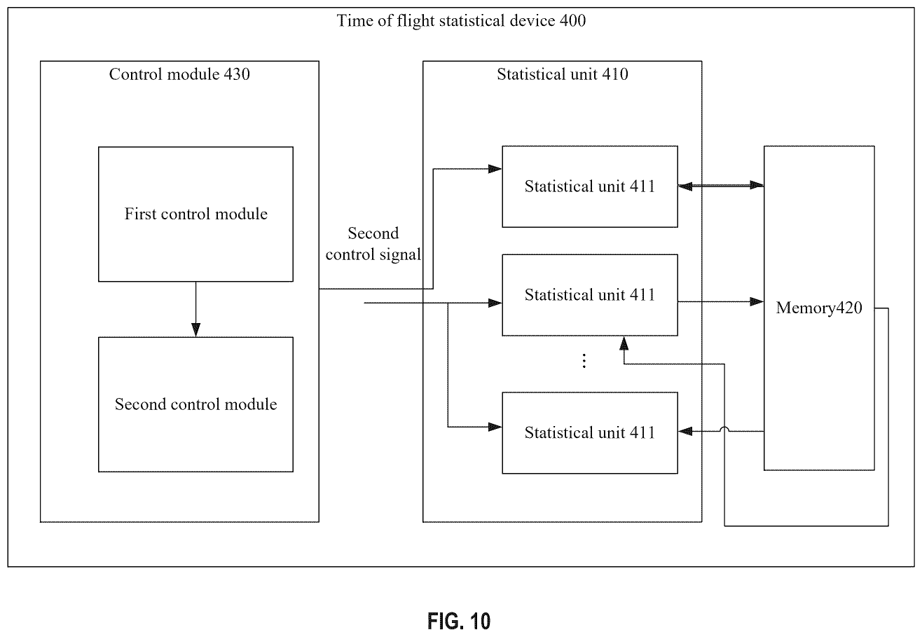

Embodiment Two provides another laser ranging device, the laser ranging device includes a light emitting unit 100, a pixel unit 200, a time-to-digital converter 300 (Time-To-Digital Converter, TDC), and a time of flight statistical device 400. Referring to a structural schematic diagram of a time of flight statistical device shown in FIG. 10, the time of flight statistical device 400 includes a control module 430, a statistical unit 410, and a memory 420. Based on the time of flight statistical device with different structures, the laser ranging device can realize two detection modes compared with the laser ranging device provided in Embodiment One. Specifically, the laser ranging device in Embodiment Two can realize a first detection mode and a second detection mode.

When the laser ranging device is in the first detection mode, the statistical unit 410 is configured to acquire S first initial time of flight data sets corresponding to S first integration periods, and perform accumulation processing on each first initial time of flight data set in groups of every N adjacent initial time of flight data to generate S accumulated time of flight data sets corresponding to the S first initial time of flight data sets in one-to-one manner, where S is a positive integer greater than or equal to 2, and N is a positive integer greater than or equal to 2. The time of flight statistical device is further configured to perform superposition processing on the S accumulated time of flight data sets to generate a first superposition time of flight data set, store the first superposition time of flight data set in the memory 420 in a manner that at least one first superposition photon count value in the first superposition time of flight data set is stored in one storage unit according to one first superposition photon count value, and the first superposition time of flight data set includes a first superposition photon count value corresponding to each accumulated time of flight moment in one-to-one manner.

Each first initial time of flight data set includes a plurality of first initial time of flight data, each first initial time of flight data includes one time of flight moment output by the TDC and a photon count value corresponding to the time of flight moment; each accumulated time of flight data set includes at least one accumulated time of flight data, each accumulated time of flight data includes at least one accumulated time of flight moment after accumulation of N adjacent time of flight moments and at least one accumulated photon count value corresponding to the at least one accumulated time of flight moment in one-to-one manner. The first superposition time of flight data set includes at least one first superposition time of flight data obtained by performing superposition processing on accumulated time of flight data corresponding to the same accumulated time of flight moment in the S accumulated time of flight data sets, and each first superposition time of flight data includes a first superposition photon count value obtained by the S accumulated photon count values corresponding to the at least one accumulated time of flight moment.

When the laser ranging device is in the second detection mode, the statistical unit 410 is configured to acquire S second initial flight time data sets in S second integration periods, superimpose the S second initial flight time data sets to generate a second superimposed flight time data set, and store the second superimposed flight time data set in the memory 420 in a manner that at least one second superimposed photon count value in the second superimposed flight time data set is stored in one storage unit according to one second superimposed photon count value.

Each second initial flight time data set includes a plurality of second initial flight time data, and each second initial flight time data includes a plurality of flight moments output by the TDC and a plurality of photon count values corresponding to the plurality of flight moments in a one-to-one manner.

In the second embodiment, it is assumed that each first integration period includes X*N first clock periods, each first clock period includes M first initial flight time data, each second integration period includes X second clock periods, and each second clock period includes M second initial flight time data, where X is greater than or equal to 2, M is greater than or equal to 2, M=K*N, M, K, and X are positive integers, and K is greater than or equal to 1. Referring to a schematic structural diagram of a time-of-flight statistical device shown in FIG. 10, the statistical unit 410 in the time-of-flight statistical device 400 includes K statistical modules 411 connected in parallel.

When the laser ranging device is in the first detection mode, the second control signal output by the control module is in the first state, and the M first initial flight time data corresponding to each clock period are divided into K first initial flight time data sets according to the first division manner. The K statistical modules are configured to acquire, under the action of the second control signal in the first state, the K first initial flight time data sets in each first clock period in each first integration period in the order of clock periods, and perform accumulation processing on the acquired first initial flight time data sets to generate accumulated flight time data sets. The K statistical modules are further configured to perform superimposition processing on the S accumulated flight time data sets under the action of the second control signal in the first state to generate a first superimposed flight time data set, store the first superimposed flight time data set in the memory 420 in a manner that at least one first superimposed photon count value in the first superimposed flight time data set is stored in one storage unit according to one first superimposed photon count value.

The first division manner is a division manner in which every adjacent N first initial flight time data is a group, and M first initial flight time data corresponding to each first clock period in each first integration period is divided into K groups of first initial flight time data, that is, K first initial flight time data sets. Exemplarily, assuming that the M first initial flight time data included in each first clock period are sequentially represented as P0, P1, . . . , P[K*N−2] to P[K*N−1], and K*N=M, the kth first initial flight time data set in each first clock period is {P[k*N−N] to P[k*N−1]}, and the kth first initial flight time data set corresponds to the kth statistical module in the K statistical modules. It should be noted that when the laser ranging device is in the first detection mode, the statistical unit 410 superimposes the accumulated flight time data sets corresponding to the first to S first integration periods in a continuous superposition manner, and the method for generating the first superimposed flight time data set can be referred to the related description in Embodiment 1, and details are not described herein again.

When the laser ranging device is in the second detection mode, the second control signal output by the control module is in the second state, and the M second initial flight time data corresponding to each clock period are divided into K groups of second initial flight time data according to the second division manner. That is, K second initial flight time data sets are obtained. The K statistical modules are used for acquiring, under the action of the second control signal in the second state, the K second initial flight time data sets in each second clock period in each second integration period in the order of clock periods.

The second division manner is a division manner in which P[0*K+(k−1)] to P[(N−1)*K+(k−1)] (k=1 to K) are a group, and the M initial flight time data corresponding to each second clock cycle in each second integration cycle are divided into K second initial flight time data sets, and the kth second initial flight time data set in each second clock cycle is {P[0*K+(k−1)], P[1*K+(k−1)], . . . , P[(N−1)*K+(k−1)]}, and the kth second initial flight time data set corresponds to a kth statistical module in the K statistical modules. It should be noted that when the laser ranging device is in the second detection mode, the kth statistical module is configured to acquire N second initial flight time data included in the kth second initial flight time data set {P[0*K+(k−1)], P[1*K+(k−1)], . . . , P[(N−1)*K+(k−1)]} under the action of the second control signal in the second state, and store the N second initial flight time data included in the kth second initial flight time data set {P[k*N−N] to P[k*N−1]} in one corresponding storage unit. When the K statistical modules acquire the second initial flight time data sets corresponding to the first to S second integration cycles, the K statistical modules are further configured to perform superposition processing on the S second initial flight time data sets corresponding to the first to S second integration cycles under the action of the second control signal in the second state, generate a second superposition flight time data set, and store M second superposition photon count values included in the second superposition flight time data set in M corresponding storage units.

In the embodiment of the application, when the laser ranging device is in the second detection mode, the statistical unit 410 can also perform superposition processing on the second initial flight time data sets corresponding to the first to S second integration cycles in a continuous superposition manner to generate the second superposition flight time data set.

Specifically, when the K statistical modules obtain the second initial flight time data set corresponding to the first second integration period, the K statistical modules write the second initial flight time data set corresponding to the first second integration period into the memory. When the K statistical modules obtain the initial flight time data set corresponding to the second second integration period, the K statistical modules read the second initial flight time data set corresponding to the first second integration period from the memory, and perform first superposition processing on the second initial flight time data set corresponding to the first second integration period and the second initial flight time data set corresponding to the second second integration period to obtain a first second superposition flight time data set, and write the first second superposition flight time data set into the memory. When the K statistical modules obtain the initial flight time data set corresponding to the third second integration period, the K statistical modules read the first second superposition flight time data set from the memory, and perform second superposition processing on the first second superposition flight time data set and the second initial flight time data set corresponding to the third second integration period to obtain a second second superposition flight time data set, and write the second second superposition flight time data set into the memory. By analogy, the above operation is performed continuously for multiple times, until when the K statistical modules obtain the second initial flight time data set corresponding to the S second integration period, the K statistical modules read the S−2 second superposition flight time data set from the memory, perform S−1 superposition processing on the S−2 second superposition flight time data set and the second initial flight time data set corresponding to the S second integration period to obtain the S−1 second superposition flight time data set, and write the S−1 second superposition flight time data set into the memory 420.

In the embodiment of the application, the number of the storage units included in the memory 420 is X*M, where X is a positive integer and X is greater than or equal to 1. When the laser ranging device is in the first detection mode, the X*M storage units included in the memory can store a maximum of X*M (i.e. X*N*K) accumulated photon count values, and accordingly, the number of clock cycles included in the first integration period can reach a maximum of (X*N*K)/K (i.e. X*N); the detection distance L1 that can be achieved by the laser ranging device in the first integration period is L1=c*(X*N*t), where c is the speed of light and t is the length of one clock cycle; and the detection precision Δt1 of the laser ranging device in the first detection mode is Δt1=N*t. When the laser ranging device is in the second detection mode, the X*M storage units included in the memory can store a maximum of X*M initial flight time data, and accordingly, the number of clock cycles included in the second integration period can reach a maximum of (X*M)/M (i.e. X); the detection distance L2 that can be achieved by the laser ranging device in the second integration period is L2=c*(X*t); and the detection precision Δt2 of the laser ranging device in the second detection mode is Δt2=t. As can be seen from the above, L1=N*L2 and Δt1=N*Δt2. That is, the detection distance of the laser ranging device in the first detection mode is greater than that in the second detection mode, and the detection requirement of the laser ranging device on a long detection distance can be met; and the detection precision of the laser ranging device in the second detection mode is less than that in the first detection mode, and the detection requirement of the laser ranging device on high detection precision can be met.

Based on the laser ranging device provided in Embodiment Two of the application, different detection requirements of the laser ranging device can be met by switching the detection mode. The time of flight statistical device provided in the application controls each statistical module to output the accumulated photon count value or the initial flight time data to the memory by using the second control signal, thereby facilitating the simplification of the structure of each statistical module while achieving the time of flight statistics in the two detection modes of the laser ranging device.

Further, the X*M storage units in the memory can be divided into X storage modules, the storage addresses of the X storage modules are a0, a1, . . . , aX−1 respectively, and each storage module includes M storage units. The X*N first clock cycles included in one first integration period can be divided into X first statistical periods, each first statistical period includes N clock cycles, and the X second clock cycles included in one second integration period can be divided into X second statistical periods, each second statistical period includes 1 clock cycle.

When the laser ranging device is in the first detection mode, the M storage units of the storage module with the storage address of ax−1 are used for storing N*K accumulated photon count values accumulated by the K statistical modules in the xth first statistical period of the current first integration period, that is, N*K accumulated photon count values corresponding to the N first clock periods included in the xth first statistical period. When the laser ranging device is in the second detection mode, the M storage units of the storage module with the storage address of ax−1 are used for storing the M second initial time-of-flight data corresponding to the xth second clock period (that is, the xth second statistical period) of the current second integration period obtained by the K statistical modules.

Specifically, when the laser ranging device is in the first detection mode, the K statistical modules are used for performing accumulation processing on the N*M first initial time-of-flight data corresponding to the N first clock periods included in the current first statistical period, and storing the N*K accumulated photon count values obtained by the accumulation in the M storage units of the current storage module, and then the output ends of the K statistical modules are directed to the next storage module. The K statistical modules are used for performing accumulation processing on the N*M first initial time-of-flight data corresponding to the N first clock periods included in the next first statistical period, and storing the N*K accumulated photon count values obtained by the accumulation in the M storage units of the next storage module. The above operation is repeatedly performed until the output ends of the K statistical modules are directed to the storage module with the storage address of aX−1, the K statistical modules perform accumulation processing on the N*M first initial time-of-flight data corresponding to the N first clock periods included in the Xth first statistical period, and store the N*K accumulated photon count values obtained by the accumulation in the storage module with the storage address of aX−1. After the K statistical modules complete the statistics of all the first initial time-of-flight data in the current first integration period, the control module stops controlling the K statistical modules to work. If there is a first integration period in which the statistics of the time of flight is not completed in a single time frame, when the next first integration period comes, the control module controls the K statistical modules to work again, so that the time-of-flight statistical device completes the statistics of all the first initial time-of-flight data in the next first integration period. After the time-of-flight statistical device completes the statistics of all the first initial time-of-flight data in the S first integration periods in a single time frame, the control module can stop controlling the K statistical modules to work again until the next time frame comes.

When the laser ranging device is in the second detection mode, and the K statistical modules store the M second initial flight time data corresponding to the current second clock cycle in the M storage units of the current storage module, the output ends of the K statistical modules are directed to the next storage module. The K statistical modules store the M second initial flight time data corresponding to the next second clock cycle in the M storage units of the next storage module. The operation is repeated until the output ends of the K statistical modules are directed to the storage module with the storage address of aX−1, and the K statistical modules store the M second initial flight time data corresponding to the Xth second clock cycle in the current second integration cycle in the storage module with the storage address of aX−1. When the K statistical modules complete the flight time statistics in the current second integration cycle, the control module stops controlling the K statistical modules to work. If there is a second integration cycle in a single time frame that has not completed the flight time statistics, the control module controls the K statistical modules to work again when the next second integration cycle comes, so that the flight time statistical device completes the flight time statistics in the next second integration cycle. When the flight time statistical device completes the flight time statistics of all the second integration cycles in a single time frame, the control module can stop controlling the K statistical modules to work again until the next time frame comes.

In the embodiment, the control module is configured to output a control signal. As shown in FIG. 10, the control module includes a first control module and a second control module. The first control module is configured to output a first control signal and a second control signal, where the first control signal is a clock cycle control signal, and the second control signal is a sampling mode control signal. The second control signal can be in a first state or a second state, the laser ranging device is in the first detection mode (i.e., the accumulation sampling mode) when the second control signal is in the first state, and the laser ranging device is in the second detection mode (i.e., the normal sampling mode) when the second control signal is in the second state; and the second control module is configured to output a combined control signal according to the first control signal and the second control signal output by the first control module. Exemplarily, the second control module can be an AND gate.

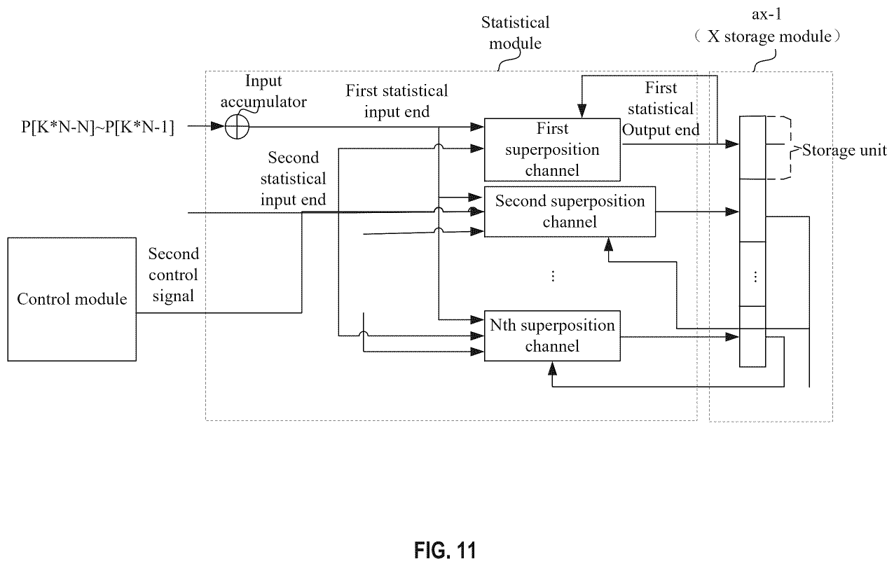

In the embodiment, the K statistical modules in the statistical unit are of the same structure. As shown in FIG. 11, in an implementation of the embodiment, each statistical module includes one input accumulator and N superposition channels connected in parallel, i.e., a first superposition channel, a second superposition channel, and an Nth superposition channel, and the input accumulator and the N superposition channels connected in parallel are connected in series.

Specifically, the input accumulator includes N input ends and one output end, and each superposition channel includes a first statistical input end, a second statistical input end, a first superposition output end, and a superposition feedback end. Among them, the input accumulator of each statistical module is used to respectively obtain the K groups of first initial flight time data sets in each first clock cycle within each first integration period, and perform accumulation processing on each group of initial flight time data sets in the K groups of first initial flight time data sets, generating the accumulated flight time data set corresponding to each first integration period.

The output end of the input accumulator is connected with the first statistical input ends of the first superposition channel, the second superposition channel to the Nth superposition channel. When the second control signal is in the first state, the N first superposition input ends are used for receiving N*K accumulated photon count values generated by the input accumulator in N first clock periods in each first statistical period of each first integration period in one-to-one correspondence according to the second control signal.

Specifically, when the second control signal output by the control module is in the first state, the laser ranging device is in the first detection mode. According to the order of the first clock periods in each first statistical period, the first statistical input end of the nth superposition channel included in the K statistical modules allows the input accumulator of each statistical module to input the K accumulated photon count values accumulated in the nth first clock period of the current first statistical period, and other superposition channels (i.e., other superposition channels of the N superposition channels of each statistical module except the nth superposition channel) in the K statistical modules prohibit the input accumulator of each statistical module from inputting the K accumulated photon count values accumulated in the nth clock period. When the Nth superposition channel of the K statistical modules completes the input of the K accumulated photon count values accumulated in the Nth clock period by the input accumulator of each statistical module, that is, after the K statistical modules complete the input of the N*K accumulated photon count values in the first clock period to the Nth clock period of the current first statistical period, the K statistical modules again complete the input of the N*K accumulated photon count values in the first first clock period to the Nth first clock period of the next first statistical period by the input accumulator of each statistical module according to the order of the first clock periods in the next first statistical period, until the K statistical modules complete the input of the X*N*K accumulated photon count values in the X first statistical periods of the current first integration period. When the laser ranging device enters the next first integration period, the K statistical modules again perform the above operation to complete the input of the X*N*K accumulated photon count values in the X first statistical periods of the next first integration period, until the input of the accumulated photon count values in all the required first integration periods is completed.

The second statistical input ends of the first superposition channel to the Nth superposition channel of the K statistical modules are respectively configured to acquire the second initial time-of-flight data set corresponding to the statistical module in each second clock cycle of each second integration cycle. And when the second control signal is in the second state, the output ends of the first superposition channel to the Nth superposition channel of the K statistical modules are sequentially directed to the X storage modules in the memory in the order of the X second clock cycles in each integration cycle, that is, K*N superposition output ends corresponding to the first superposition channel to the Nth superposition channel of the K statistical modules are directed to the current corresponding statistical module in the current second statistical cycle and are directed to a next corresponding storage module in a next second statistical cycle.

Specifically, when the second control signal output by the control module is in the second state, the laser ranging device is in the second detection mode. According to the order of the X second clock cycles (i.e., the second statistical periods) in each second integration period, the second statistical input ends of the first to Nth superposition channels included in the K statistical modules allow input of K sets of second initial flight time data of each second clock cycle, and the operation is repeated until the first to Nth superposition channels included in the K statistical modules complete input of K sets of second initial flight time data of the Xth second clock cycle, and the first to Nth superposition channels included in the K statistical modules complete input of X*M second initial flight time data of the X second clock cycles of the current second integration period. When the laser ranging device enters the next second integration period, the K statistical modules perform the above operation again to complete input of X*M second initial flight time data of the X second clock cycles of the next second integration period, until input of second initial flight time data of all required second integration periods is completed.

It should be noted that when the second control signal output by the control module is in the second state, the nth superposition channel in the kth statistical module in the K statistical modules is used to obtain the nth second initial flight time data in the kth set of second initial flight time data {P[0*K+(k−1)], P[1*K+(k−1)], . . . , P[(N−1)*K+(k−1)]} of one second clock cycle, that is, the K statistical modules correspond to K sets of second initial flight time data of each second clock cycle in a one-to-one manner, and the nth superposition channel in the kth statistical module corresponds to the nth second initial flight time data in the N second initial flight time data of the kth set of second initial flight time data of each second clock cycle. The K*N superposition output ends included in the K statistical modules are sequentially directed to the write-in ends of the X storage modules included in the memory according to the order of the second clock cycles in each second integration period, that is, each second clock cycle corresponds to one storage module, and the K*N superposition output ends included in the K statistical modules are directed to the write-in end of the storage module with the storage address of ax−1 in the xth clock cycle of each second integration period. The readout ends of the X storage modules included in the memory 420 are sequentially directed to the K*N superposition feedback ends included in the K statistical modules according to the order of the second clock cycles in each second integration period, that is, the readout end of the storage module with the storage address of ax−1 is directed to the K*N superposition feedback ends included in the K statistical modules in the xth second clock cycle of each second integration period.

In an example, the structure and function of each statistical module are exemplarily described by taking the kth statistical module in the K statistical modules as an example.

Specifically, when the second control signal output by the control module is in the first state, the laser ranging device is in the first detection mode. The input accumulator included in the kth statistical module is used for acquiring the kth set of first initial flight time data P[k*N−N] to P[k*N−1] in each first clock cycle, and performing accumulation processing on the N first initial flight time data P[k*N−N] to P[k*N−1] to generate a kth accumulated photon count value. The first superposition channel included in the kth statistical module is turned on in the first first clock cycle of each first statistical cycle, so that the kth accumulated photon count value generated by the input accumulator of the kth statistical module in the first first clock cycle of the first statistical cycle is stored in the corresponding storage unit of the current storage module corresponding to the first statistical cycle. The nth superposition channel included in the kth statistical module is turned on in the nth first clock cycle of each first statistical cycle, so that the kth accumulated photon count value generated by the input accumulator of the kth statistical module in the nth first clock cycle of the first statistical cycle is stored in the one-to-one corresponding storage unit of the current storage module. The Nth superposition channel included in the kth statistical module is turned on in the Nth first clock cycle of each first statistical cycle, so that the kth accumulated photon count value generated by the input accumulator of the kth statistical module in the Nth first clock cycle of the first statistical cycle is stored in the one-to-one corresponding storage unit of the current storage module; n is a positive integer, and 1≤n≤N.

When the laser ranging device is in the first detection mode, the time of flight statistical device sequentially turns on the first superposition channel, the second superposition channel to the Nth superposition channel according to the N clock cycle order of the first statistical cycle in each first statistical module, to realize the accumulation sampling and storage of the first initial flight time data corresponding to each first statistical cycle, and ensure that the statistics of the first initial flight time data of each first clock cycle will not interfere with each other. Δt the same time, the first superposition channel, the second superposition channel to the Nth superposition channel are sequentially turned on X times repeatedly, to realize the accumulation sampling and storage of the first initial flight time data corresponding to each first integration cycle, without increasing the number of superposition channels, and the structure is simple.

For example, assuming that the first integration period includes N*X clock cycles, the laser ranging device can achieve a detection distance L1=c*(N*X*t) in the first integration period, where c is the speed of light, and t is the duration of one clock cycle. The kth statistical module acquires N*X pieces of the kth set of first initial time-of-flight data P[k*N−N] to P[k*N−1] corresponding to the N*X clock cycles in the order of the clock cycles, and accumulatively samples the kth set of first initial time-of-flight data P[k*N−N] to P[k*N−1] in the N*X clock cycles to generate N*X accumulative photon count values. The kth statistical module is further configured to store the N*X accumulative photon count values obtained by the accumulative sampling of the N*X clock cycles corresponding to each first integration period in one-to-one corresponding N*X storage units under the control of the second control signal in the first state output by the control module. The K statistical modules acquire N*X pieces of K sets of first initial time-of-flight data corresponding to the N*X clock cycles in the order of the clock cycles, generate N*X*K, i.e., M*X accumulative photon count values, and are further configured to store the M*X accumulative photon count values in one-to-one corresponding M*X storage units. When the laser ranging device ends one first integration period, the control module stops controlling the K statistical modules to work until the next first integration period arrives, and the control module controls the K statistical modules to store the accumulative photon count values obtained by the accumulative sampling in the next first integration period in one-to-one corresponding storage units.

When the second control signal output by the control module is in the second state, the laser ranging device is in the second detection mode.

The kth statistical module is configured to acquire the kth set of second initial flight time data of each second clock cycle in the second integration period, where the kth set of second flight time data includes N second initial flight time data P[(k−1)], P[(k−1)+(N−2)*K] to P[(k−1)+(N−1)*K] of M second initial flight time data P[0] to P[K*N−1] of each second clock cycle. The N superposition channels included in the kth statistical module are turned on under the action of the second control signal; the first superposition channel of the kth statistical module is configured to store the nth second initial flight time data in the kth set of second initial flight time data of each second clock cycle acquired by the kth statistical module in one storage unit of the current storage module; the nth superposition channel of the kth statistical module is configured to store the nth second initial flight time data in the kth set of second initial flight time data of each second clock cycle acquired by the kth statistical module in one storage unit of the current storage module; and the Nth superposition channel of the kth statistical module is configured to store the Nth second initial flight time data in the kth set of second initial flight time data of each second clock cycle acquired by the kth statistical module in one storage unit of the current storage module, so that sampling and storage of the second initial flight time data corresponding to each second clock cycle in each second integration period are realized.

For example, it is assumed that the number of clock cycles included in the second integration period is X, and the detection distance L2 that the laser ranging device can achieve in the second integration period is c*(X*t), where c is the speed of light, and t is the length of one clock cycle. The kth statistical module acquires X sets of kth second initial flight time data {P[0*K+(k−1)], P[1*K+(k−1)], . . . , P[(N−1)*K+(k−1)]} corresponding to X second clock cycles in the second integration period in the order of the second clock cycles in the second integration period, and stores the X sets of kth second initial flight time data {P[0*K+(k−1)], P[1*K+(k−1)], . . . , P[(N−1)*K+(k−1)]} obtained in the X clock cycles corresponding to each second integration period in the one-to-one corresponding N*X storage units under the control of the second control signal in the second state output by the control module. The K statistical modules store the X*M second initial flight time data in the one-to-one corresponding N*X*K (i.e., X*M) storage units in the order of clock cycles. When the laser ranging device ends one second integration period, the control module stops controlling the K statistical modules to work until the next second integration period comes, and the control module controls the K statistical modules to store the initial flight time data in the next second integration period in the one-to-one corresponding storage units again.

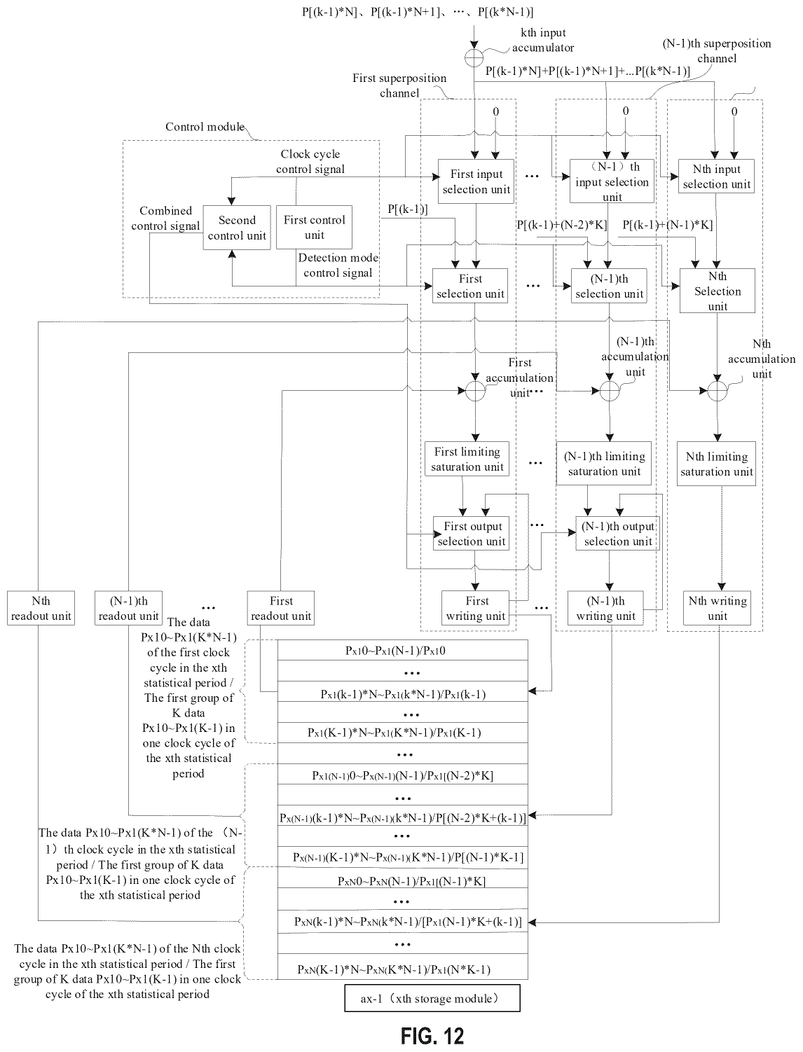

In the embodiment two, the structures of the first superposition channel to the (N−1)th superposition channel in each statistical module are the same, and the structure of the Nth superposition channel in each statistical module is different from the structures of the first N−1 superposition channels. The specific structure of the first N superposition channels in each statistical module is described below with reference to the structure diagram of the kth statistical module in the K statistical modules shown in FIG. 12, taking the first N−1 superposition channels (i.e., the n superposition channel in the first superposition channel to the (N−1)th superposition channel) in the kth statistical module as an example, where n is a positive integer and 1≤n≤N−1.

In an implementation, the n superposition channel of each statistical module includes an n input selection unit, an n selection unit, an n accumulation unit, an n limit saturation unit, an n output selection unit, an n write unit, and an n read unit.

Specifically, the n input selection unit includes two input terminals, one output terminal, and one control terminal. One of the input terminals is connected with the output terminal of the input accumulator in the statistical module, the other input terminal receives data 0. The output terminal is connected with one input terminal of the n selection unit, and the control terminal is connected with the output terminal of the first control module in the control module. When the second control signal is in the first state, the n input selection unit is configured to select the accumulated photon count value of the kth set of first initial time-of-flight data corresponding to the n first clock cycle and output the accumulated photon count value to the n selection unit in the n first clock cycle in each first statistical cycle according to the second control signal.

The n selection unit includes two input terminals, one output terminal, and one control terminal. One of the input terminals is configured to obtain the n initial time-of-flight data in the kth set of second initial time-of-flight data in each clock cycle, the kth set of second time-of-flight data includes N initial time-of-flight data P[(k−1)], P[(k−1)+(N−2)*K] to P[(k−1)+(N−1)*K] in M initial time-of-flight data P[0] to P[K*N−1] of each clock cycle, and the other input terminal is connected with the output terminal of the n selection unit. The output terminal is connected with one input terminal of the n accumulation unit, and the control terminal is connected with the output terminal of the first control module in the control module. When the second control signal is in the first state, the n selection unit is configured to select the accumulated photon count value of the kth set of first initial time-of-flight data corresponding to the n first clock cycle and output the accumulated photon count value to the n accumulation unit in the n first clock cycle in each first statistical cycle according to the second control signal. When the second control signal is in the second state, the n selection unit is configured to select the n second initial time-of-flight data in the kth set of second initial time-of-flight data in the n second clock cycle and output the n second initial time-of-flight data to the n accumulation unit in the n second clock cycle in each second integration cycle according to the second control signal.

The nth accumulation unit includes two input terminals and one output terminal, where one input terminal is connected to the output terminal of the nth selection unit, and the output terminal is connected to the input terminal of the nth limiting saturation unit.

The nth limiting saturation unit includes one input terminal and one output terminal, where the input terminal is connected to the output terminal of the nth accumulation unit, and the output terminal is connected to one input terminal of the nth output selection unit.

The nth output selection unit includes two input terminals, one output terminal, and one control terminal, where one input terminal is connected to the output terminal of the nth limiting saturation unit, another input terminal is connected to an output terminal of the nth writing unit, the output terminal is connected to the input terminal of the nth writing unit, and the control terminal is connected to the output terminal of the second control module in the control module.

When the second control signal is in the first state, the nth output selection unit is used to output the data from the nth limiting saturation unit to the nth writing unit according to the first control signal, during the nth first clock cycle of each first statistical period. When the second control signal is in the second state, the nth output selection unit is used to output the data from the nth writing unit to the nth writing unit according to the second control signal, during the nth second clock cycle.

The nth writing unit includes one input terminal and two output terminals, where the input terminal is connected to the output terminal of the nth output selection unit, one output terminal is connected to another input terminal of the nth output selection unit, and the other output terminal is connected to a memory.

The nth readout unit includes one input terminal and one output terminal, where the input terminal is connected to the memory, and the output terminal is connected to another input terminal of the nth accumulation unit.

Refer to FIG. 12, in one implementation, each statistical module's Nth superposition channel includes the Nth input selection unit, the Nth selection unit, the Nth accumulation unit, the Nth limiting saturation unit, the Nth writing unit, and the Nth readout unit.

Specifically, the Nth input selection unit includes two input terminals, one output terminal, and one control terminal, where one input terminal is connected to the output terminal of the input accumulator of the statistical module, another input terminal receives data 0, the output terminal is connected to one input terminal of the Nth selection unit, and the control terminal is connected to the output terminal of the first control module in the control module.

When the second control signal is in the first state, the Nth input selection unit is used to select the accumulated photon count value of the kth group of initial flight time data corresponding to the Nth first clock cycle, based on the second control signal in the first state, during the Nth first clock cycle of each first statistical period, and output it to the Nth selection unit. Among them, when the second control signal is in the first state, the Nth input selection unit is used to select, based on the second control signal in the first state, the accumulated photon count value of the kth group of first initial flight time data corresponding to the Nth first clock cycle within each first statistical cycle, and output it to the Nth selection unit.

The Nth selection unit includes two input terminals, an output terminal and a control terminal, one of the input terminals is used for acquiring the Nth initial flight time data in the kth group of second initial flight time data in each clock cycle, the kth group of second flight time data includes N initial flight time data P[(k−1)], P[(k−1)+(N−2)*K] to P[(k−1)+(N−1)*K] in M initial flight time data P[0] to P[K*N−1] of each clock cycle, the other input terminal is connected with the output terminal of the Nth selection unit, the output terminal is connected with one input terminal of the Nth accumulation unit, and the control terminal is connected with the output terminal of the first control module in the control module. When the second control signal is in the first state, the Nth selection unit is used for selecting the accumulated photon count value of the kth group of first initial flight time data corresponding to the Nth first clock cycle in each Nth first clock cycle in each first statistical cycle and outputting the accumulated photon count value to the Nth accumulation unit according to the second control signal in the first state. When the second control signal is in the second state, the Nth selection unit is used for selecting the Nth second initial flight time data in the kth group of second initial flight time data in each Nth second clock cycle in each second integration cycle and outputting the Nth second initial flight time data to the Nth accumulation unit according to the second control signal in the second state.

In an example, when the second control signal output by the control module is in the first state, the laser ranging device is in the first detection mode, if N=2, that is, the number of superposition channels included by each statistical module is two; each first integration cycle includes X first statistical cycles, and the number of first clock cycles included by each first statistical cycle is two, that is, the number of first clock cycles included by each first integration cycle is 2*X; and then for S first integration cycles, the specific working processes of the first superposition channel to the Nth superposition channel of the K statistical modules in the S first integration cycles respectively include the following steps:

Step s2x1: when the second control signal output by the control module is in the first state, the laser ranging device is in the first detection mode, the input accumulators of the K statistic modules respectively acquire K sets of the first initial flight time data {P0 to P[N−1]}, . . . , {P[k*N−N] to P[k*N−1]}, . . . , {P[K*N−N] to P[K*N−1]} in the first first clock cycle of the first first integration cycle in the S first integration cycles, and accumulates the K sets of the first initial flight time data {P0 to P[N−1]}, . . . , {P[k*N−N] to P[k*N−1]}, . . . , {P[K*N−N] to P[K*N−1]} and generates K accumulated photon count values in the first first clock cycle, where x is a positive integer, and 1≤x≤X. The first input selection units of the K statistic modules, under the action of the second control signal output by the control module and in the first state, allow the K accumulated photon count values accumulated in the first first clock cycle by the K input accumulators to pass through and output. The second input selection units to the Nth input selection units of the K statistic modules, under the action of the second control signal output by the control module, prohibit the K accumulated photon count values accumulated in the first first clock cycle by the K input accumulators to pass through and instead allow data 0 to pass through and output. The first selection units of the K statistic modules, under the action of the second control signal output by the control module and in the first state, allow the K accumulated photon count values accumulated in the first first clock cycle and output by the K first input selection units to pass through and output. The K accumulated photon count values output by the K first selection units pass through the first accumulation unit of the first superposition channel in sequence and are output to the first limiting saturation unit of the first superposition channel, the first limiting saturation unit is used for limiting a bit width of an accumulated flight time corresponding to an accumulated photon count value that can pass through, when the bit width of the accumulated flight time corresponding to the accumulated photon count value input to the first limiting saturation unit does not exceed the limit bit width of the first limiting saturation unit, the first limiting saturation unit allows the accumulated photon count value to pass through and output to the first output selection unit, and the first output selection unit, under the control of the combination control signal output by the control module, allows the accumulated photon count value to pass through and output to the first write unit in the first superposition channel; and when the bit width of the accumulated flight time in the accumulated photon count value input to the first limiting saturation unit exceeds the limit bit width of the first limiting saturation unit, the first limiting saturation unit prohibits the accumulated photon count value from passing through.

Step s2x2: when the second control signal output by the control module is in the first state, the laser ranging device is in the first detection mode, the input accumulators of the K statistical modules respectively acquire K sets of first initial flight time data {P0 to P[N−1]}, . . . , {P[k*N−N] to P[k*N−1]}, . . . , {P[K*N−N] to P[K*N−1]} in a second first clock period of an xth first statistical period of a first first integration period, and perform accumulation processing on the K sets of first initial flight time data {P0 to P[N−1]}, . . . , {P[k*N−N] to P[k*N−1]}, . . . , {P[K*N−N] to P[K*N−1]} to generate K accumulated photon count values in the first first clock period; the second input selection units of the K statistical modules, under the action of the second control signal in the first state output by the control module, allow the K accumulated photon count values obtained by the K input accumulators in the second first clock period to pass through and be output; the first input selection unit, the third to Nth input selection units of the K statistical modules, under the action of the second control signal in the first state output by the control module, do not allow the K accumulated photon count values obtained by the K input accumulators in the second first clock period to pass through, but allow data 0 to pass through and be output. The second selection units of the K statistical modules, under the action of the second control signal in the first state output by the control module, allow the K accumulated photon count values obtained by the K second input selection units in the second first clock period to pass through and be output. The K accumulated photon count values output by the K second selection units pass through the second accumulation units of the second superposition channels in sequence and are output to the second limiting saturation units of the second superposition channels. The second limiting saturation units are used for limiting the bit width of the accumulated flight time in the accumulated photon count values that can pass through. If the bit width of the accumulated flight time in the accumulated photon count values input to the second limiting saturation units does not exceed the limited bit width of the second limiting saturation units, the second limiting saturation units allow the accumulated photon count values to pass through and be output to the second output selection units. The second output selection units, under the control of the combined control signal output by the control module, allow the accumulated photon count values to pass through and be output to the second write units in the second superposition channels. If the bit width of the accumulated flight time in the accumulated photon count values input to the second limiting saturation units exceeds the limited bit width of the second limiting saturation units, the second limiting saturation units do not allow the accumulated photon count values to pass through.

Step s2x3: when the second control signal output by the control module is in the first state, the laser ranging device is in the first detection mode, if the first writing unit to the Nth writing unit of the K statistical modules store the N*K accumulated photon count values obtained by the K input accumulators in the xth first statistical period of the first first integration period in the N*K storage units (i.e., the M storage units) of the current storage module (i.e., the (x−1)th storage module), the first writing unit to the Nth writing unit of the K statistical modules point to the next storage module (i.e., the xth storage module), the input accumulators of the K statistical modules continue to obtain the initial time of flight data in the (x+1)th statistical period of the first first integration period, and the first superposition channel to the second superposition channel of the K statistical modules repeat the above steps s2x1 and s2x2 for X times, until the first superposition channel to the second superposition channel of the K statistical modules sequentially complete the steps S211, S212, . . . , the steps S2x1, S2x2, . . . , to the steps S2X1, S2X2 in the X statistical periods of the first first integration period. Referring to the storage schematic diagram of the time of flight data in the first integration period shown in FIG. 7, the first superposition channel to the second superposition channel of the K statistical modules sequentially complete the accumulated sampling of the K groups of first initial time of flight data {P0 to P[N−1]}, . . . , {P[k*N−N] to P[k*N−1]}, . . . , {P[K*N−N] to P[K*N−1]} in each clock cycle of the X*N first clock cycles of the X first statistical periods of the first first integration period, and store the obtained X*N*K accumulated photon count values corresponding to the X*N first clock cycles in the X*N*K storage units (i.e., X*M storage units) of the X storage modules, and complete the accumulated sampling and storage of the first initial time of flight data in the X first statistical periods of the first first integration period.

After the accumulated sampling and storage of all the first initial time of flight data in the X statistical periods of the first first integration period in the S first integration periods are completed based on the steps s2x1 to s2x3, when the first superposition channel to the second superposition channel of the K statistical modules enter the second first integration period, the accumulated photon count values at the same accumulated flight moment in the first first integration period are sequentially read from the storage and output to the first accumulation unit to the Nth accumulation unit of the K statistical modules, so as to perform the first superposition on the accumulated photon count values at the same accumulated flight moment in the first first integration period and the second first integration period, obtain a first superposed time of flight data set, and store the obtained X*N*K first superposed photon count values corresponding to the X*N clock cycles in the X*N*K storage units of the X storage modules. The specific superposition steps can be referred to the related description in embodiment I, and will not be described herein.

In another example, when the second control signal output by the control module is in the second state, the laser ranging device is in the second detection mode. If N=2, each second integration period includes X second statistical periods, and each second statistical period includes one second clock period, that is, the number of second clock periods included in each second integration period is 2*X. Then, for S second integration periods, the specific working processes of the first superposition channel to the Nth superposition channel of the K statistical modules in the S second integration periods respectively include the following steps:

Step s3x1: when the second control signal output by the control module is in the second state, the laser ranging device is in the second detection mode. In the first second clock period in the first second integration period, the first selection unit of the K statistical modules is used for respectively acquiring the first second initial flight time data in each set of second initial flight time data in the K sets of second initial flight time data in the first second clock period, and under the action of the second control signal in the second state output by the control module, the first selection unit selects the first second initial flight time data in each set of second initial flight time data to be output to the corresponding first limit saturation unit. If the bit width of the flight moment corresponding to the second initial flight time data input into the first limit saturation unit does not exceed the limit bit width of the first limit saturation unit, the first limit saturation unit allows the first second initial flight time data in each set of second initial flight time data in the first second clock period to pass through and be output to the first output selection unit, and the first output selection unit allows the first second initial flight time data in each set of second initial flight time data in the first second clock period to pass through and be output to the first write unit in the first superposition channel under the control of the combination control signal output by the control module.

The second selection unit of the K statistical modules respectively acquires the second second initial flight time data in each set of second initial flight time data in the K sets of second initial flight time data in the first second clock period, and under the action of the second control signal in the second state output by the control module, the second selection unit selects the second second initial flight time data in each set of second initial flight time data to be output to the corresponding second limit saturation unit. If the bit width of the flight moment corresponding to the second initial flight time data input into the second limit saturation unit does not exceed the limit bit width of the second limit saturation unit, the first limit saturation unit allows the second second initial flight time data in each set of second initial flight time data in the first second clock period to pass through and be output to the second output selection unit, and the second output selection unit allows the second second initial flight time data in each set of second initial flight time data in the first second clock period to pass through and be output to the second write unit in the second superposition channel under the control of the combination control signal output by the control module.

Step s3x2: In a second clock cycle of the first second integration period, when the second control signal output by the control module is in the second state, the laser ranging device is in the second detection mode, the first selection unit of the K statistical modules is used for respectively acquiring a first second initial flight time data in each set of second initial flight time data in the K sets of second initial flight time data in the second clock cycle, and under the action of the second control signal in the second state output by the control module, the first selection unit selects the first second initial flight time data in each set of second initial flight time data and outputs the first second initial flight time data to a corresponding first limit saturation unit, if a bit width of a flight moment corresponding to the second initial flight time data input to the first limit saturation unit does not exceed a limit bit width of the first limit saturation unit, the first limit saturation unit allows the first second initial flight time data in each set of second initial flight time data in the second clock cycle to pass through and output the first second initial flight time data to a first output selection unit, and the first output selection unit, under the control of the combined control signal output by the control module, allows the first second initial flight time data in each set of second initial flight time data in the second clock cycle to pass through and output the first second initial flight time data to a first write unit in the first superposition channel.

The second selection unit of the K statistical modules respectively acquires a second second initial flight time data in each set of second initial flight time data in the K sets of second initial flight time data in the second clock cycle, and under the action of the second control signal in the second state output by the control module, the second selection unit selects the second second initial flight time data in each set of second initial flight time data and outputs the second second initial flight time data to a corresponding second limit saturation unit, if a bit width of a flight moment corresponding to the second initial flight time data input to the second limit saturation unit does not exceed a limit bit width of the second limit saturation unit, the first limit saturation unit allows the second second initial flight time data in each set of second initial flight time data in the second clock cycle to pass through and output the second second initial flight time data to a second output selection unit, and the second output selection unit, under the control of the combined control signal output by the control module, allows the second second initial flight time data in each set of second initial flight time data in the second clock cycle to pass through and output the second second initial flight time data to a second write unit in the second superposition channel.

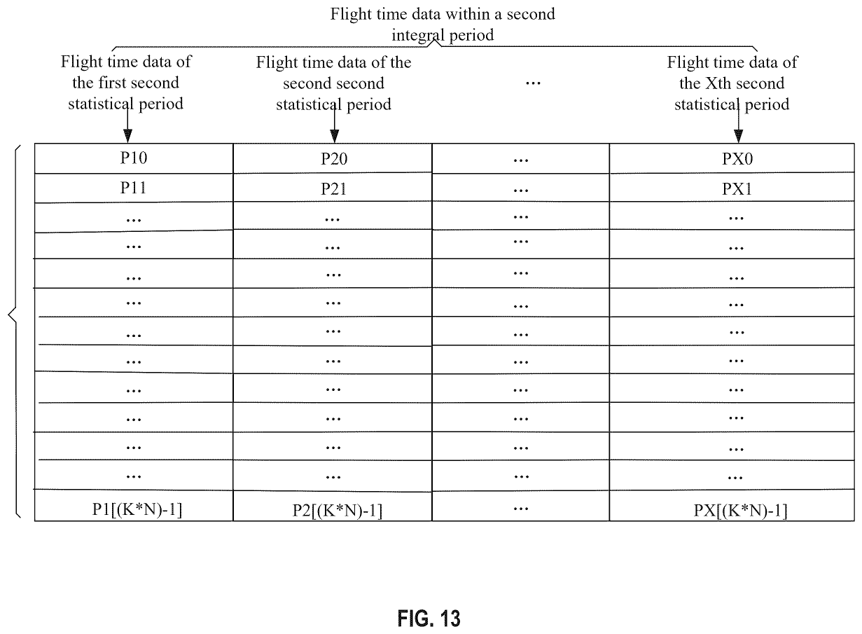

Step s3x3: if the first writing unit to the Nth writing unit of the K statistical modules store the N*K second initial flight time data obtained by the first selection unit to the Nth selection unit in the xth second clock cycle of the first second integration period in the N*K storage units (i.e. M storage units) of the current storage module (i.e. the x−1 storage module), the first writing unit to the Nth writing unit of the K statistical modules point to the next storage module (i.e. the xth storage module), the first selection unit to the Nth selection unit of the K statistical modules continue to obtain the second initial flight time data in the (x+1)th second clock cycle of the first second integration period, the first superposition channel to the second superposition channel repeat the above steps s3x1 and s3x2 for X times, until the first superposition channel to the second superposition channel of the K statistical modules sequentially complete the steps S311, S312, . . . . S3x1, S3x2, . . . , to S3X1, S3X2 in the X second clock cycles of the first second integration period. Referring to the schematic diagram of the storage of the second initial flight time data in the second integration period shown in FIG. 13, the first superposition channel to the second superposition channel of the K statistical modules sequentially store the M second initial flight time data in each clock cycle of the X first clock cycles of the X second clock cycles of the first second integration period in the X*N*K storage units (i.e. X*M storage units) of the X storage modules, and the storage of the second initial flight time data in the X second clock cycles of the first second integration period is completed.

After the sampling and storage of all the second initial flight time data in the first second integration period are completed based on the steps s3x1 to s3x3, when the first superposition channel to the second superposition channel of the K statistical modules enter the second second integration period, the second initial flight time data at the same flight moment in the same second clock cycle of the first second integration period are sequentially read from the storage and output to the first accumulation unit to the Nth accumulation unit of the K statistical modules, so that the second initial flight time data at the same flight moment in the first second integration period and the second second integration period are subjected to first superposition, a first superposed flight time data set is obtained, and X*M second superposed photon count values corresponding to the X second clock cycles are stored in the X*M storage units of the X storage modules.

In an embodiment, the nth selection unit in each statistical module includes a data selector MUXn, which is a 2-to-1 data selector. The data selector MUXn includes two data input terminals, one data output terminal and one selection input terminal. One data input terminal of the nth data selector MUXn is connected to the output terminal of the nth input selection unit in the statistical module, the other data input terminal is used to obtain the second initial time-of-flight data, the data output terminal is connected to one input terminal of the nth accumulator in the statistical module, and the selection input terminal is connected to the signal output terminal of the control module.

When the second control signal output by the control module is in the first state, the laser ranging device is in the first detection mode, and the data selector MUXn_selects and outputs the accumulated photon count value output by the nth input selection unit in the nth clock cycle of each statistical cycle under the action of the second control signal in the first state; when the second control signal output by the control module is in the second state, the laser ranging device is in the second detection mode, and the data selector MUXn_selects and outputs the corresponding second initial time-of-flight data under the action of the second control signal in the second state.

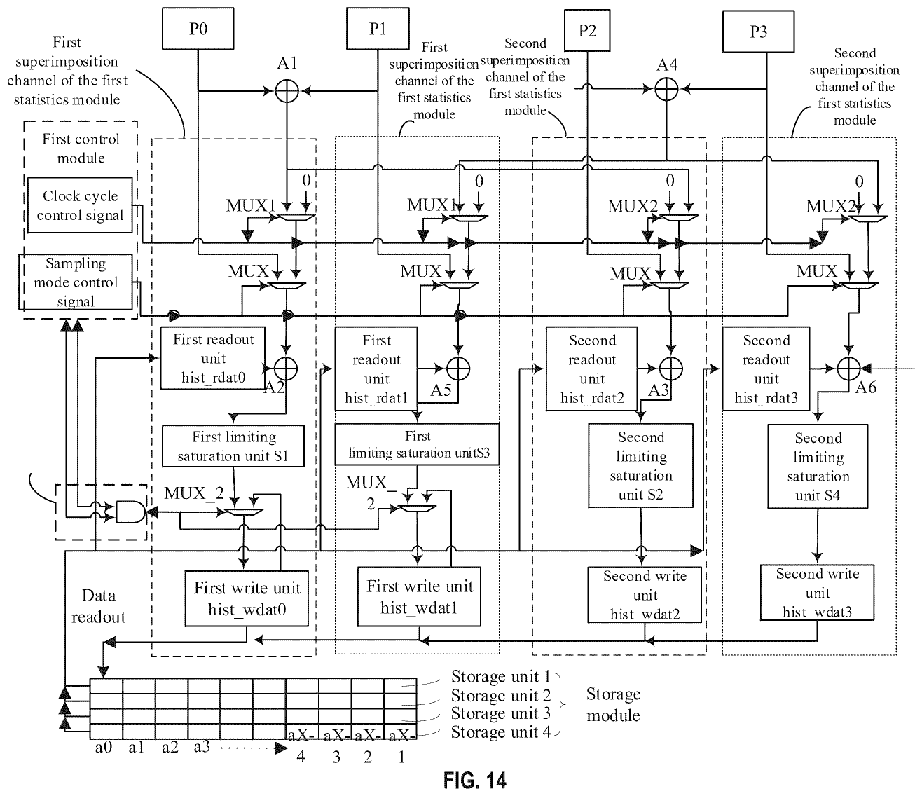

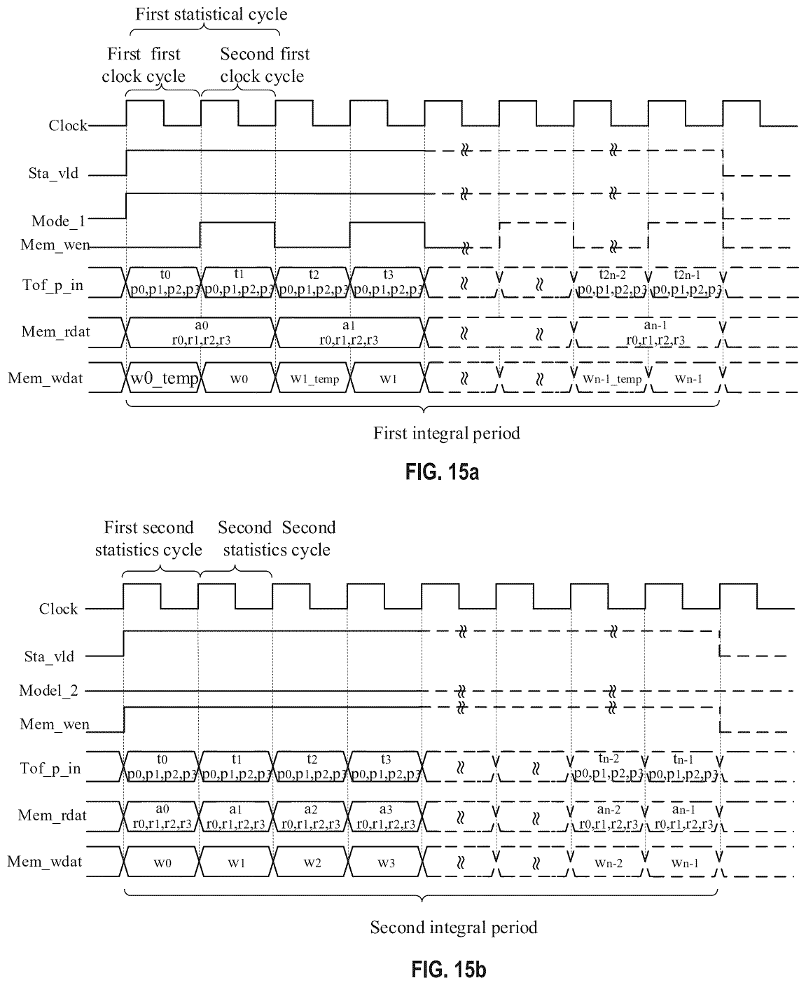

By way of example but not limitation, reference is made to the specific structure schematic diagram of a time-of-flight statistical device shown in FIG. 14 and the timing diagrams of the first integration period and the second integration period shown in FIG. 15a and FIG. 15b. In FIG. 15a and FIG. 15b, the control module outputs a clock period control signal clock, in which a continuous high level and a low level are taken as one clock period; sta_vld is a signal for controlling the integration period length, and is in a high level in one integration period; and mem_wen is periodically alternating low levels and high levels, in which a continuous low level and a high level are taken as one statistical cycle. It is assumed that M=4, N=2, and K=2; the time-of-flight statistical device includes two statistical modules, i.e., a first statistical module and a second statistical module, and each statistical module includes two superposition channels; the first integration period includes X first statistical cycles, each first statistical cycle includes two first clock periods, i.e., a first first clock period and a second first clock period, and each first integration period includes 2*X clock periods; the second integration period includes X second statistical cycles, each second statistical cycle includes one second clock period, and each second integration period includes X second clock periods; and each storage module includes four storage units.

(1) when the second control signal output by the control module is in the first state and the laser ranging device is in the first detection mode:

When the first statistical module and the second statistical module acquire two groups of first initial flight time data {P0, P1} and {P2, P3} of the first clock cycle in the xth statistical cycle in the first integration period, the input accumulator A1 of the first statistical module and the input accumulator A4 of the second statistical module respectively accumulate the two groups of first initial flight time data {P0, P1} and {P2, P3} input in the first clock cycle of the xth first statistical cycle to generate a first accumulated photon count value P01 and a second accumulated photon count value P23 corresponding to the first clock cycle.

When the first statistical module and the second statistical module acquire two groups of time-of-flight data {P0, P1} and {P2, P3} of the second first clock cycle in the xth statistical cycle in the first integration period: the input accumulator A1 of the first statistical module and the input accumulator A4 of the second statistical module respectively accumulate the two groups of first initial time-of-flight data {P0, P1} and {P2, P3} input in the second first clock cycle of the xth statistical cycle to generate a first accumulated photon count value P01 and a second accumulated photon count value P23 corresponding to the second first clock cycle.

The first data selector MUX1 and the first selector MUX1_ corresponding to the first input selection unit of the first statistical module select the first accumulated photon count value P01 corresponding to the first clock cycle under the action of the second control signal, and if the first accumulated photon count value P01 corresponding to the first clock cycle does not exceed the limit bit width of the first limiting saturation unit included in the first statistical module, the data selector MUX_1 corresponding to the first output selection unit of the first statistical module selects the data output by the first limiting saturation unit included in the first statistical module, that is, the first accumulated photon count value P01, under the action of the combined control signal, and outputs the first accumulated photon count value P01 to the first write unit hist_wdat0 of the first statistical module. The first data selector MUX1 and the first selector MUX1 corresponding to the first input selection unit of the second statistical module select the second accumulated photon count value P23 corresponding to the first clock cycle under the action of the second control signal. The data selector MUX1 and the first selector MUX1_ corresponding to the first input selection unit of the second statistical module select the second accumulated photon count value P23 corresponding to the first clock cycle under the action of the second control signal, and if the second accumulated photon count value P23 corresponding to the first clock cycle does not exceed the limit bit width of the first limiting saturation unit included in the second statistical module, the data selector MUX_2 corresponding to the first output selection unit of the second statistical module selects the data output by the first limiting saturation unit included in the second statistical module, that is, the second accumulated photon count value P23, under the action of the combined control signal, and outputs the second accumulated photon count value P23 to the first write unit hist_wdat1 of the second statistical module.

When the first statistical module and the second statistical module acquire two groups of time-of-flight data {P0, P1} and {P2, P3} of the second first clock cycle in the xth statistical cycle in the first integration period: the input accumulator A1 of the first statistical module and the input accumulator A4 of the second statistical module respectively accumulate the two groups of first initial time-of-flight data {P0, P1} and {P2, P3} input in the second first clock cycle of the xth statistical cycle to generate a first accumulated photon count value P01 and a second accumulated photon count value P23 corresponding to the second first clock cycle. The data selector MUX1 corresponding to the first input selection unit of the first statistical module and the data selector MUX1_ corresponding to the first selection unit are allowed to pass through and output data 0 under the action of the second control signal, the data selector MUX1_ corresponding to the first output selection unit of the first statistical module is allowed to pass through and output the data temporarily stored by the first write unit of the first statistical module under the action of the combined control signal, that is, the first accumulated photon count value P01 corresponding to the second first clock cycle is output to the first write unit of the first statistical module; the data selector MUX2 corresponding to the second input selection unit of the first statistical module and the data selector MUX2_ corresponding to the first selection unit select the first accumulated photon count value P01 corresponding to the second first clock cycle under the action of the control signal, and if the first accumulated photon count value P01 corresponding to the second clock cycle does not exceed the limit bit width of the second limiting saturation unit included in the first statistical module, the second limiting saturation unit included in the first statistical module outputs the first accumulated photon count value P01 corresponding to the second first clock cycle; the data selector MUX2_ corresponding to the second output selection unit of the first statistical module obtains the data output by the second limiting saturation unit included in the first statistical module, that is, the first accumulated photon count value P01 corresponding to the second first clock cycle, under the action of the combined control signal, and outputs the data to the second write unit hist_wdat2 of the first statistical module; the data selector MUX1 corresponding to the first input selection unit of the second statistical module and the data selector MUX1_ corresponding to the first selection unit are allowed to pass through and output data 0 under the action of the second control signal, the data selector MUX1_ corresponding to the first output selection unit of the second statistical module is allowed to pass through and output the data temporarily stored by the first write unit of the second statistical module under the action of the combined control signal, that is, the second accumulated photon count value P23 corresponding to the first first clock cycle is output to the first write unit of the second statistical module; the data selector MUX2 corresponding to the second input selection unit of the second statistical module and the data selector MUX2_ corresponding to the first selection unit select the second accumulated photon count value P23 corresponding to the second first clock cycle under the action of the second control signal, and if the second accumulated photon count value P23 corresponding to the second first clock cycle does not exceed the limit bit width of the second limiting saturation unit included in the second statistical module, the second limiting saturation unit included in the second statistical module outputs the second accumulated photon count value P23 corresponding to the second first clock cycle; and the data selector MUX2 corresponding to the second output selection unit of the second statistical module obtains the data output by the second limiting saturation unit included in the second statistical module, that is, the second accumulated photon count value P23 corresponding to the second first clock cycle, under the action of the combined control signal, and outputs the data to the second write unit hist_wdat3 of the second statistical module.

Δt this time, the first write unit of the first statistical module temporarily stores the first accumulated photon count value P01 corresponding to the first first clock cycle in the first integration period, and the first write unit of the second statistical module temporarily stores the second accumulated photon count value P23 corresponding to the first first clock cycle; the second write unit of the first statistical module temporarily stores the first accumulated photon count value P01 corresponding to the second first clock cycle, and the second write unit of the second statistical module temporarily stores the second accumulated photon count value P23 corresponding to the second first clock cycle; the first write unit and the second write unit of the first statistical module and the first write unit and the second write unit of the second statistical module write the four accumulated photon count values (i.e. the first accumulated photon count value P01, the second accumulated photon count value P23 corresponding to the first first clock cycle of the xth statistical period and the first accumulated photon count value P01, the second accumulated photon count value P23 corresponding to the second first clock cycle of the xth statistical period) obtained by the input accumulators of the two statistical modules in the two first clock cycles of the xth first statistical period into the storage module with the storage address ax−1.

In this embodiment, when the storage module with the storage address of ax−1 is written with the four accumulated photon count values corresponding to the xth statistical cycle by the two first statistical modules, and xX, the first writing unit, the second writing unit of the first statistical module and the first writing unit, the second writing unit of the second statistical module point to a storage module with a storage address of ax. The first statistical module and the second statistical module continue to perform the accumulated sampling of the first initial time of flight data in the (x+1)th statistical cycle in the current first integration period and store the data in the storage module with the storage address of ax. When the storage module with the storage address of aX−1 (here, X is an uppercase letter) is written with the four accumulated photon count values corresponding to the Xth statistical cycle by the two statistical modules, that is, after the first statistical module and the second statistical module complete the accumulated sampling and storage of the first initial time of flight data in the current first integration period, the control module stops outputting the control signal until the next first integration period arrives, and the control module again performs the accumulated sampling and storage of the first initial time of flight data in the X statistical cycles in the first integration period.

It should be noted that when the statistical unit performs the operation of the next first integration period, the first readout unit of the first statistical module is configured to read and output the first accumulated photon count value P01 corresponding to the first clock cycle of the xth first statistical period of the previous first integration period to the first accumulation unit of the first statistical module in the xth first statistical period of the next first integration period; the first readout unit of the second statistical module is configured to read and output the second accumulated photon count value P23 corresponding to the first clock cycle of the xth first statistical period of the previous first integration period to the first accumulation unit of the second statistical module in the xth first statistical period of the next first integration period; the second readout unit of the first statistical module is configured to read and output the first accumulated photon count value P01 corresponding to the second clock cycle of the xth first statistical period of the previous first integration period to the second accumulation unit of the first statistical module in the xth first statistical period of the next first integration period; and the second readout unit of the second statistical module is configured to read and output the second accumulated photon count value P23 corresponding to the second clock cycle of the xth first statistical period of the previous first integration period to the second accumulation unit of the second statistical module in the xth first statistical period of the next first integration period, so as to realize superposition of the second accumulated photon count values corresponding to a plurality of first integration periods, until the input accumulators of the K statistical modules complete accumulation sampling of the first initial time-of-flight data of the Sth first integration period, the K statistical modules complete superposition of the second accumulated photon count values corresponding to all the first integration periods, and finally generate histogram data.

(2) when the second control signal output by the control module is in the second mode and the laser ranging device is in the second detection mode:

The first statistical module and the second statistical module respectively acquire two groups of second initial time-of-flight data {P0, P2} and {P1, P3} in a first second clock cycle in the second integration period, the first selector MUX1 of the first statistical module selects the first second initial time-of-flight data P0 in the first group of second initial time-of-flight data corresponding to the first second clock cycle under the action of the second control signal in the second mode, and if the second initial time-of-flight data P0 does not exceed the limit bit width of the first limit saturation unit included in the first statistical module, the data selector MUX_1 corresponding to the first output selection unit of the first statistical module selects the data output by the first limit saturation unit included in the first statistical module, that is, the first second initial time-of-flight data P0 in the first group of second initial time-of-flight data corresponding to the first second clock cycle, under the action of the combined control signal, and outputs the data to the first write unit hist_wdat0 of the first statistical module.

The second selector MUX2 of the first statistical module selects a first second initial flight time data P1 in the second group of second initial flight time data corresponding to the first second clock cycle under the action of the second control signal in the second mode, and if the second initial flight time data P1 does not exceed the limited bit width of the first limiting saturation unit included in the first statistical module, a data selector MUX_1 corresponding to a second output selection unit of the first statistical module selects the data output by the first limiting saturation unit included in the first statistical module, that is, the first second initial flight time data P1 in the second group of second initial flight time data corresponding to the first second clock cycle, under the action of the combined control signal, and outputs the data to a second write unit hist_wdat1 of the first statistical module.

The first selector MUX1 of the second statistical module selects a second second initial flight time data P2 in the first group of second initial flight time data corresponding to the first second clock cycle under the action of the second control signal in the second mode, and if the second initial flight time data P2 does not exceed the limited bit width of the first limiting saturation unit included in the second statistical module, a data selector MUX_1 corresponding to a first output selection unit of the second statistical module selects the data output by the first limiting saturation unit included in the second statistical module, that is, the second second initial flight time data P2 in the first group of second initial flight time data corresponding to the first second clock cycle, under the action of the combined control signal, and outputs the data to a first write unit hist_wdat2 of the second statistical module.

The second selector MUX2 of the second statistical module selects the second second initial flight time data P3 in the second group of second initial flight time data corresponding to the first second clock cycle under the action of the second control signal. If the second initial flight time data P3 does not exceed the limit bit width of the second limiting saturation unit included in the second statistical module, the data selector MUX_1 corresponding to the first output selection unit of the second statistical module selects the data output by the second limiting saturation unit included in the second statistical module, that is, the second second initial flight time data P3 in the second group of second initial flight time data corresponding to the first second clock cycle, under the action of the combined control signal, and outputs the data to the second write unit hist_wdat3 of the second statistical module. In this embodiment, when the storage module with the storage address ax−1 (here, x is in lowercase) is written with the four second initial flight time data corresponding to the xth second clock cycle in the second integration period, and xX, the first write unit and the second write unit of the first statistical module and the first write unit and the second write unit of the second statistical module point to the storage module with the storage address ax. The first statistical module and the second statistical module continue to acquire the four second initial flight time data of the (x+1)th second clock cycle in the current second integration period and store the four second initial flight time data in the storage module with the storage address ax. When the storage module with the storage address aX−1 (here, X is in uppercase) is written with the four second initial flight time data corresponding to the Xth second clock cycle by the two statistical modules, that is, after the first statistical module and the second statistical module complete the storage of the second initial flight time data of the current second integration period, the control module stops outputting the control signal until the next second integration period comes, and the control module executes the storage operation of the second initial flight time data of the X second clock cycles in the second integration period again.

It should be noted that when the statistical unit performs the operation of the next second integration period, the first readout unit of the first statistical module is configured to read and output the first second initial flight time data P0 corresponding to the xth second clock cycle of the previous second integration period to the first accumulation unit of the first statistical module at the xth second clock cycle of the next second integration period; the first readout unit of the second statistical module is configured to read and output the second second initial flight time data P1 corresponding to the xth second clock cycle of the previous second integration period to the first accumulation unit of the second statistical module at the xth second clock cycle of the next second integration period; the second readout unit of the first statistical module is configured to read and output the third second initial flight time data P2 corresponding to the xth second clock cycle of the previous second integration period to the second accumulation unit of the first statistical module at the xth second clock cycle of the next second integration period; and the second readout unit of the second statistical module is configured to read and output the fourth second initial flight time data P3 corresponding to the xth second clock cycle of the previous second integration period to the second accumulation unit of the second statistical module at the xth second clock cycle of the next second integration period, so as to realize superposition of the second initial flight time data corresponding to the plurality of first integration periods, until the input accumulators of the K statistical modules complete accumulation sampling of the second initial flight time data of the S second integration period, and the K statistical modules complete superposition of the second initial flight time data corresponding to all the second integration periods, to generate the final histogram data.

In an implementation, based on the same inventive concept, the application further provides a time-of-flight statistical method based on the time-of-flight statistical device provided in the above embodiment one, the method including: acquiring S first initial flight time data sets in S first integration periods, and performing accumulation processing on each first initial flight time data set in groups of every N adjacent first initial flight time data to obtain S accumulated flight time data sets corresponding to the S first initial flight time data sets in a one-to-one manner, where S is a positive integer, S is greater than or equal to 2, N is a positive integer, and N is greater than or equal to 2; each first initial flight time data set includes a plurality of first initial flight time data corresponding to a plurality of flight moments in a one-to-one manner, and each accumulated flight time data set includes at least one accumulated photon count value corresponding to at least one accumulated flight moment in a one-to-one manner; performing superposition processing on the S accumulated flight time data sets to obtain a superposed flight time data set, and storing the superposed flight time data set in a memory in a manner that at least one superposed photon count value in the superposed flight time data set is stored in one storage unit as one superposed photon count value, where the superposed flight time data set includes superposed photon count values corresponding to each accumulated flight moment in a one-to-one manner.

In an implementation, based on the same inventive concept, the application further provides a time of flight statistical method based on the time of flight statistical device provided in the above embodiment two. The method includes: in a first detection mode, acquiring S first initial time of flight data sets in S first integration periods, and performing accumulation processing on each first initial time of flight data set in groups of every N adjacent first initial time of flight data to obtain S accumulated time of flight data sets corresponding to the S first initial time of flight data sets one by one, where S is a positive integer, S is greater than or equal to 2, N is a positive integer, and N is greater than or equal to 2; each first initial time of flight data set includes a plurality of first initial time of flight data corresponding to a plurality of flight moments, and each accumulated time of flight data set includes at least one accumulated photon count value corresponding to at least one accumulated flight moment; performing superposition processing on the S accumulated time of flight data sets to obtain a superposition time of flight data set, and storing the superposition time of flight data set in a memory in a manner that at least one superposition photon count value in the superposition time of flight data set is stored in one storage unit according to one superposition photon count value, and the superposition time of flight data set includes a superposition photon count value corresponding to each accumulated flight moment. In a second detection mode, S second initial time of flight data sets in S second integration periods are acquired, superposition processing is performed on the S second initial time of flight data sets to obtain a second superposition time of flight data set, and the second superposition time of flight data set is stored in the memory in a manner that at least one second superposition photon count value in the second superposition time of flight data set is stored in one storage unit according to one second superposition photon count value; the second superposition time of flight data set includes a second superposition photon count value corresponding to each flight moment, and each second initial time of flight data set includes a second initial time of flight data corresponding to a plurality of flight moments.

It should be noted that the specific implementation process in the time-of-flight statistical method embodiment can refer to the specific working processes of the modules in the time-of-flight statistical device in the above embodiment one and embodiment two, and details are not described herein again. For the convenience and brevity of description, only the division of the above functional units and modules is exemplified, and in the actual application, the above functions can be completed by different functional units and modules according to needs, that is, the internal structure of the device is divided into different functional units or modules to complete all or part of the functions described above. Each functional unit and module in the embodiment can be integrated in one processing unit, or each unit can be physically present separately, or two or more units can be integrated in one unit. The integrated unit can be realized in the form of hardware or in the form of a software functional unit. In addition, the specific names of the functional units and modules are only for convenient mutual distinction, and are not used to limit the protection scope of the application. Based on the same inventive concept, the embodiment of the application further provides a terminal device. The embodiment of the application further provides a computer readable storage medium, which stores a computer program. When the computer program is executed by a processor, the specific process of the above statistical method embodiment is performed. The embodiment of the application further provides a computer program product. When the computer program product is run on the photon counting laser ranging device, the photon counting laser ranging device is enabled to realize the specific process of the above statistical method embodiment.

The integrated unit, if realized in the form of a software functional unit and sold or used as an independent product, can be stored in a computer-readable storage medium. Based on such an understanding, the application can realize all or part of the processes in the above embodiment methods by instructing related hardware through a computer program. The computer program can be stored in a computer-readable storage medium. The computer program, when executed by a processor, can perform the steps of the above method embodiments. The computer program includes computer program code, which can be in the form of source code, object code, an executable file, or some intermediate form. The computer-readable storage medium can include at least any entity or device capable of carrying the computer program code to a photographing device/terminal device, a recording medium, a computer memory, a read-only memory (ROM), a random access memory (RAM), an electrical carrier signal, a telecommunications signal, and a software distribution medium, such as a U disk, a mobile hard disk, a magnetic disk, or an optical disk.

Reference herein to “one embodiment” or “some embodiments” means that a particular feature, structure, or characteristic described in connection with the embodiment is included in at least one embodiment of the application. The appearances of the phrase “in one embodiment,” “in some embodiments,” “in other embodiments,” “in additional embodiments,” and so on, in various places in the specification are not necessarily all referring to the same embodiment, nor are separate or alternative embodiments mutually exclusive of other embodiments. The terms “comprises,” “comprising,” “includes,” “including,” “has,” “having,” and their conjugates mean “including but not limited to,” unless otherwise expressly specified and limited. In the description of the application, it needs to be understood that the terms “first” and “second” are used for description purpose only and cannot be understood as indicating or implying relative importance or implicitly specifying the number of the technical features indicated. Therefore, the features defined with “first” and “second” can explicitly or implicitly include at least one of the features. In addition, in the present application, unless otherwise specifically specified and limited, the terms “connection,” “connection,” and the like should be understood in a broad sense, for example, it can be mechanical connection, or electrical connection; it can be direct connection, or indirect connection through an intermediate medium, it can be the internal communication of two elements or the interaction relationship of two elements, unless otherwise specifically limited, and the specific meaning of the above terms in the present application can be understood according to the specific circumstances by those skilled in the art.

The above embodiments are only used to illustrate the technical solutions of the present application, rather than limit the present application. Although the present application is described in detail with reference to the above embodiments, those skilled in the art should understand that the technical solutions recorded in the above embodiments can still be modified, or some or all of the technical features can be replaced by equivalents; and these modifications or replacements do not make the essence of the corresponding technical solutions deviate from the scope of the technical solutions of the embodiments of the present application.

What is claimed is:

1. A time of flight (TOF) statistical device, comprising: a statistical unit and a memory;
wherein the statistical unit is configured to acquire S sets of first initial time of flight data in S first integration periods, and perform accumulation processing on each set of first initial time of flight data in groups of every N adjacent first initial time of flight data to obtain S sets of accumulated time of flight data corresponding to the S sets of first initial time of flight data, wherein S is a positive integer greater than or equal to 2, and N is a positive integer greater than or equal to 2;
wherein each set of first initial time of flight data comprises a plurality of first initial time of flight data corresponding to a plurality of flight moments, and each set of accumulated time of flight data comprises at least one accumulated photon count value corresponding to at least one accumulated flight moment; and
wherein the statistical unit is further configured to perform superposition processing on the S sets of accumulated time of flight data to obtain a set of superposed time of flight data, and store the set of superposed time of flight data in the memory in a manner that at least one superposed photon count value in the set of superposed time of flight data is stored in one storage unit according to one superposed photon count value, wherein the set of superposed time of flight data comprises a superposed photon count value corresponding to each accumulated flight moment.

2. The TOF statistical device according to claim 1, wherein each first integration period comprises X*N clock periods, and each clock period comprises M first initial time of flight data, wherein X is greater than or equal to 2, M is greater than or equal to 2, and X and M are positive integers;
wherein the statistical unit comprises a control module and K statistical modules connected in parallel;
wherein the control module is configured to output a first control signal;
wherein the K statistical modules are configured to respectively acquire K groups of sets of first initial time of flight data in each clock period of each first integration period, and perform accumulation processing on N first initial time of flight data in each group of first initial time of flight data according to the first control signal to obtain the S sets of accumulated time of flight data corresponding to the S first integration periods, wherein M equals to K*N, K is greater than or equal to 1, and K is a positive integer; and
wherein the K statistical modules are further configured to perform superposition processing on the S sets of accumulated time of flight data to obtain the set of superposed time of flight data, and store the set of superposed time of flight data in the memory in a manner that at least one superposed photon count value in the set of superposed time of flight data is stored in one storage unit according to one superposed photon count value.

3. The TOF statistical device according to claim 2, wherein the K statistical modules are further configured to, according to the first control signal, store, in one storage module, N*K accumulated photon count values corresponding to N*K groups of first initial TOF data included in N clock cycles in one statistical period, wherein the X*N clock cycles in each first integration period are divided into the statistical periods each of which includes N clock cycles; and
wherein the memory comprises X storage modules, and each storage module comprises N*K storage units, and the N*K storage units in each storage module are respectively configured to store N*K accumulated photon count values corresponding to N clock cycles in one statistical period.

4. The TOF statistical device according to claim 2, wherein each statistical module comprises an input accumulator and N superposition channels connected in parallel;
wherein the input accumulator comprises N inputs and one output, and K input accumulators in the K statistical modules are configured to respectively acquire K groups of first initial TOF data sets in each clock cycle in each first integration period, and perform accumulation processing on each group of initial TOF data sets in the K groups of first initial TOF data sets to generate an accumulated TOF data set corresponding to each first integration period;
wherein each superposition channel comprises a first superposition input, a superposition output, and a superposition feedback input;
wherein N first superposition inputs of the N superposition channels are connected with the output of the input accumulator, and the N first superposition inputs are configured to receive N*K accumulated photon count values generated by the input accumulator in N clock cycles in each statistical period of each first integration period one by one according to the first control signal;
wherein N first superposition outputs of the N superposition channels are connected with a write-in end of the memory, and the N superposition outputs are configured to store the N*K accumulated photon count values generated by the input accumulator in N clock cycles in each statistical period of each first integration period in N*K storage units of the memory according to the first control signal; and
wherein N superposition feedback inputs of the N superposition channels are connected with outputs of N storage units in the memory corresponding to the N first superposition outputs one by one.

5. The TOF statistical device according to claim 4, wherein for the N superposition channels of the kth statistical module in the K statistical modules, an nth superposition channel in the first N−1 superposition channels of the N superposition channels comprises an nth input selection unit, an nth accumulation unit, an nth limit saturation unit, an nth output selection unit, an nth write-in unit, and an nth read-out unit, wherein n is a positive integer and 1≤n≤N−1, and k is a positive integer and 1≤k≤K;
wherein the nth input selection unit comprises two input terminals, one output terminal, and one control terminal; one input terminal of the nth input selection unit is connected with the output terminal of the input accumulator of the kth statistical module, the other input terminal is used for receiving data 0, the output terminal is connected with the nth accumulation unit, and the control terminal is connected with the control module; in the nth clock cycle in each statistical cycle, the nth input selection unit is used for outputting the accumulated photon count value of the kth group of first initial time-of-flight data corresponding to the nth clock cycle to the nth accumulation unit according to the first control signal;
wherein the nth accumulation unit comprises two input terminals and one output terminal; one input terminal of the nth accumulation unit is connected with the output terminal of the nth input selection unit, and the output terminal is connected with the input terminal of the nth limit saturation unit;
wherein the nth limit saturation unit comprises one input terminal and one output terminal; the input terminal of the nth limit saturation unit is connected with the output terminal of the nth accumulation unit, and the output terminal is connected with one input terminal of the nth output selection unit;
wherein the nth output selection unit comprises two input terminals, one output terminal, and one control terminal; one input terminal of the nth output selection unit is connected with the output terminal of the nth limit saturation unit, the other input terminal is connected with one output terminal of the nth write unit, the output terminal is connected with the input terminal of the nth write unit, and the control terminal is connected with the output terminal of the control module; in the nth clock cycle in each statistical cycle, the nth output selection unit is used for outputting the data output by the nth limit saturation unit to the nth write unit according to the first control signal;
wherein the nth write unit comprises one input terminal and two output terminals; the input terminal of the nth write unit is connected with the output terminal of the nth output selection unit, one output terminal is connected with one input terminal of the nth output selection unit, and the other output terminal is connected with the memory; and
wherein the nth read unit comprises one input terminal and one output terminal; the input terminal of the nth read unit is connected with the memory, and the output terminal is connected with the other input terminal of the nth accumulation unit.

6. The TOF statistical device according to claim 5, wherein an Nth superposition channel of the N superposition channels comprises an Nth input selection unit, an Nth accumulation unit, an Nth limit saturation unit, an Nth write unit, and an Nth read unit,
wherein the Nth input selection unit includes two input terminals, one output terminal and one control terminal, one input terminal of the Nth input selection unit is connected with the output terminal of the input accumulator of the kth statistical module, the other input terminal is used for receiving data 0, the output terminal is connected with the Nth accumulation unit, and the control terminal is connected with the control module; in the Nth clock cycle in each statistical cycle, the Nth input selection unit is used for selecting the accumulated photon count value of the kth set of first initial flight time data corresponding to the Nth clock cycle and outputting the accumulated photon count value to the Nth accumulation unit according to the first control signal;
wherein the Nth accumulation unit includes two input terminals and one output terminal, one input terminal of the Nth accumulation unit is connected with the output terminal of the Nth input selection unit, and the output terminal is connected with the input terminal of the Nth limit saturation unit;
wherein the Nth limit saturation unit includes one input terminal and one output terminal, the input terminal of the Nth limit saturation unit is connected with the output terminal of the Nth accumulation unit, and the output terminal is connected with one input terminal of the Nth write unit;
wherein the Nth write unit includes one input terminal and two output terminals, the input terminal of the Nth write unit is connected with the output terminal of the Nth output selection unit, one output terminal is connected with one input terminal of the Nth limit saturation unit, and the other output terminal is connected with the memory; and
wherein the Nth read unit includes one input terminal and one output terminal, the input terminal of the Nth read unit is connected with the memory, and the output terminal is connected with the other input terminal of the Nth accumulation unit.

7. A time of flight (TOF) statistical device, comprising: a statistical unit and a memory,
wherein when the TOF statistical device is in a first detection mode, the statistical unit is configured to acquire S sets of first initial time of flight data in S first integration periods, and perform accumulation processing on each set of first initial time of flight data in groups of every N adjacent first initial time of flight data to obtain S sets of accumulated time of flight data corresponding to the S sets of first initial time of flight data in one-to-one correspondence, wherein S is a positive integer greater than or equal to 2, and N is a positive integer greater than or equal to 2; each set of first initial time of flight data includes a plurality of first initial time of flight data corresponding to a plurality of flight moments in one-to-one correspondence, and each set of accumulated time of flight data includes at least one accumulated photon count value corresponding to at least one accumulated flight moment in one-to-one correspondence; and the statistical unit is further configured to perform superposition processing on the S sets of accumulated time of flight data to obtain a first set of superposed time of flight data, and store the first set of superposed time of flight data in the memory in a manner that at least one first superposed photon count value in the first set of superposed time of flight data is stored in one memory unit in one first superposed photon count value, the first set of superposed time of flight data including a first superposed photon count value corresponding to each accumulated flight moment in one-to-one correspondence; and
wherein when the time of flight statistical device is in the second detection mode, the statistical unit is configured to acquire S second initial time of flight data sets in S second integration periods, superimpose the S second initial time of flight data sets to obtain a second superimposed time of flight data set, and store the second superimposed time of flight data set in the memory in a manner that at least one second superimposed photon count value in the second superimposed time of flight data set is stored in one storage unit according to one second superimposed photon count value; the second superimposed time of flight data set comprises a second superimposed photon count value corresponding to each of the flight moments, and each of the second initial time of flight data sets comprises second initial time of flight data corresponding to a plurality of flight moments in one-to-one correspondence.

8. The TOF statistical device according to claim 7, wherein each of the first integration periods comprises X*N first clock periods, each of the first clock periods comprises M first initial time of flight data, each of the second integration periods comprises X second clock periods, each of the second clock periods comprises M second initial time of flight data, X≥2, M≥2, and X and M are positive integers;
wherein the statistical unit comprises a control module and K statistical modules connected in parallel;
wherein when the second control signal is in the first state, the time of flight statistical device is in the first detection mode, the K statistical modules are configured to respectively acquire K groups of first initial time of flight data sets in each first clock period of each first integration period, and perform accumulation processing on N first initial time of flight data in each of the first initial time of flight data sets according to the second control signal to obtain S accumulated time of flight data sets corresponding to the S first integration periods in one-to-one correspondence, the K statistical modules are further configured to perform superimposition processing on the S accumulated time of flight data sets to obtain the first superimposed time of flight data set, and store the first superimposed time of flight data set in the memory in a manner that at least one first superimposed photon count value in the first superimposed time of flight data set is stored in one storage unit according to one first superimposed photon count value, M=K*N, K≥1, and K is a positive integer; and
wherein when the second control signal is in the second state, the time of flight statistical device is in the second detection mode, and the K statistical modules are configured to acquire K sets of second initial time of flight data in each second clock cycle of each second integration period according to the second control signal, superimpose the S sets of second initial time of flight data corresponding to the S second integration periods to obtain the second superimposed time of flight data set, and store the second superimposed time of flight data set in the memory by storing at least one second superimposed photon count value in the second superimposed time of flight data set in one storage unit according to one second superimposed photon count value.

9. The TOF statistical device according to claim 8, wherein the memory comprises X storage modules, and each storage module comprises N*K storage units,
wherein when the time of flight statistical device is in the first detection mode, the K statistical modules are further configured to acquire X*N first clock cycles in each first integration period according to the second control signal, store N*K accumulated photon count values corresponding to N*K sets of first initial time of flight data included in N first clock cycles in one first statistical period in one storage module according to each N first clock cycles as one first statistical period, and store N*K storage units in each storage module in the N*K accumulated photon count values corresponding to N clock cycles in one first statistical period; and
wherein when the time of flight statistical device is in the second detection mode, the K statistical modules are further configured to acquire X second clock cycles in each second integration period according to the second control signal, store N*K second initial time of flight data included in one second clock cycle in one storage module according to each second clock cycle as one second statistical period, and store N*K storage units in each storage module in the N*K second initial time of flight data corresponding to one second clock cycle.

10. The TOF statistical device according to claim 8, wherein each statistical module comprises an input accumulator and N superimposition channels connected in parallel;
wherein the input accumulator comprises N inputs and one output, and K input accumulators in the K statistical modules are configured to acquire K sets of first initial time of flight data in each clock cycle in each first integration period respectively, and perform accumulation processing on each set of initial time of flight data in the K sets of first initial time of flight data to generate an accumulated time of flight data set corresponding to each first integration period;
wherein each superimposition channel comprises a first statistical input, a second statistical input, and a first superimposition output;
wherein N first statistical inputs of the N superposition channels are connected with an output of the input accumulator; when the second control signal is in the first state, the N first superposition inputs are used for receiving N*K accumulated photon count values generated by the input accumulator in N first clock periods in each first statistical period of each first integration period one by one according to the second control signal;
wherein when the second control signal is in the second state, N second statistical inputs of the N superposition channels are used for receiving N*K second initial time of flight data of the input accumulator in each second statistical period of each second integration period one by one according to the second control signal; and
wherein N first superposition outputs of the N superposition channels are connected with a write-in end of the memory; when the second control signal is in the first state, the N superposition outputs are used for storing the N*K accumulated photon count values generated by the input accumulator in the N first clock periods in each first statistical period of each first integration period in N*K storage units of the memory according to the second control signal; when the second control signal is in the first state, the N superposition outputs are used for storing the N*K second initial time of flight data of the input accumulator in each second statistical period of each second integration period in N*K storage units of the memory according to the second control signal.

11. The TOF statistical device according to claim 10, wherein for the N superposition channels of the kth statistical module of the K statistical modules, an nth superposition channel of the first N−1 superposition channels of the N superposition channels comprises an nth input selection unit, an nth selection unit, an nth accumulation unit, an nth limit saturation unit, an nth output selection unit, an nth write-in unit, and an nth read-out unit, wherein n is a positive integer and 1≤n≤N−1, and k is a positive integer and 1≤k≤K;
wherein the nth input selection unit comprises two input ends, one output end and one control end; one input end of the nth input selection unit is connected with an output end of the input accumulator of the kth statistical module, the other input end is used for receiving data 0, the output end is connected with the nth selection unit, and the control end is connected with the control module; wherein, when the second control signal is in the first state, the nth input selection unit is used for selecting the accumulated photon count value of the kth group of first initial time of flight data corresponding to the nth first clock period and outputting the accumulated photon count value to the nth selection unit in the nth first clock period in each first statistical period according to the second control signal;
wherein the nth selection unit comprises two input terminals, one output terminal, and one control terminal, wherein one input terminal of the nth selection unit is used for acquiring the nth second initial flight time data in the kth group of second initial flight time data in each second clock cycle, the other input terminal is connected with the output terminal of the nth input selection unit, the output terminal is connected with one input terminal of the nth accumulation unit, and the control terminal is connected with the control module; wherein, when the second control signal is in the first state, the nth selection unit is used for selecting the accumulated photon count value of the kth group of first initial flight time data corresponding to the nth first clock cycle in each nth first clock cycle in the first statistical cycle and outputting the accumulated photon count value to the nth accumulation unit according to the second control signal; and when the second control signal is in the second state, the nth selection unit is used for selecting the nth second initial flight time data in the kth group of second initial flight time data in each nth second clock cycle in the second integration cycle and outputting the nth second initial flight time data to the nth accumulation unit according to the second control signal;
wherein the nth accumulation unit comprises two input terminals and one output terminal, one input terminal of the nth accumulation unit is connected with the output terminal of the nth selection unit, and the output terminal is connected with the input terminal of the nth limit saturation unit;
wherein the nth limit saturation unit comprises one input terminal and one output terminal, the input terminal of the nth limit saturation unit is connected with the output terminal of the nth accumulation unit, and the output terminal is connected with one input terminal of the nth output selection unit;
wherein the nth output selection unit comprises two input terminals, one output terminal, and one control terminal; one input terminal of the nth output selection unit is connected with the output terminal of the nth limit saturation unit, the other input terminal is connected with one output terminal of the nth write-in unit, the output terminal is connected with the input terminal of the nth write-in unit, and the control terminal is connected with the control module; wherein, when the second control signal is in the first state, the nth output selection unit is used for outputting the data output by the nth limit saturation unit to the nth write-in unit in each nth clock cycle in each statistical cycle according to the second control signal;
wherein the nth write-in unit comprises one input terminal and two output terminals, the input terminal of the nth write-in unit is connected with the output terminal of the nth output selection unit, one output terminal is connected with one input terminal of the nth output selection unit, and the other output terminal is connected with the memory; and
wherein the nth readout unit comprises one input terminal and one output terminal, the input terminal of the nth readout unit is connected with the memory, and the output terminal is connected with the other input terminal of the nth accumulation unit.

12. The TOF statistical device according to claim 11, wherein an Nth superposition channel of the N superposition channels comprises an Nth input selection unit, an Nth selection unit, an Nth accumulation unit, an Nth limit saturation unit, an Nth write unit, and an Nth read unit;
wherein the Nth input selection unit comprises two input terminals, one output terminal, and one control terminal; one input terminal of the Nth input selection unit is connected with the output terminal of the input accumulator of the kth statistical module, the other input terminal is used for receiving data 0, the output terminal is connected with the Nth selection unit, and the control terminal is connected with the control module; wherein, when the second control signal is in the first state, the Nth input selection unit is used for selecting the accumulated photon count value of the kth group of first initial time of flight data corresponding to the Nth first clock cycle and outputting the accumulated photon count value to the Nth selection unit according to the second control signal in the Nth first clock cycle in each first statistical cycle;
wherein the Nth selection unit comprises two input terminals, one output terminal, and one control terminal; one input terminal of the Nth selection unit is used for acquiring the Nth second initial time of flight data in the kth group of second initial time of flight data in each second clock cycle, the other input terminal is connected with the output terminal of the Nth input selection unit, the output terminal is connected with one input terminal of the Nth accumulation unit, and the control terminal is connected with the control module; wherein, when the second control signal is in the first state, the Nth selection unit is used for selecting the accumulated photon count value of the kth group of first initial time of flight data corresponding to the Nth first clock cycle and outputting the accumulated photon count value to the Nth accumulation unit according to the second control signal in the Nth first clock cycle in each first statistical cycle; when the second control signal is in the second state, the Nth selection unit is used for selecting the Nth second initial time of flight data in the kth group of second initial time of flight data in the Nth second clock cycle and outputting the Nth second initial time of flight data to the Nth accumulation unit according to the second control signal in the Nth second clock cycle in each second integration cycle;
wherein the Nth accumulation unit comprises two input terminals and one output terminal; one input terminal of the Nth accumulation unit is connected with the output terminal of the Nth selection unit, and the output terminal is connected with the input terminal of the Nth limit saturation unit;
wherein the Nth limit saturation unit comprises one input terminal and one output terminal; the input terminal of the Nth limit saturation unit is connected with the output terminal of the Nth accumulation unit, and the output terminal is connected with one input terminal of the Nth write unit;
wherein the Nth write unit comprises one input terminal and two output terminals; the input terminal of the Nth write unit is connected with the output terminal of the Nth limit saturation unit, one output terminal is connected with one input terminal of the Nth limit saturation unit, and the other output terminal is connected with the memory; and
wherein the Nth read unit comprises an input end and an output end, wherein the input end of the Nth read unit is connected with the memory, and the output end is connected with the other input end of the Nth accumulation unit.

13. A laser ranging device comprising the time-of-flight statistics apparatus of claim 1.
